(19) United States
(12) Patent Application Publication
(10) Pub. No.: US 2009/0061267 A1
(43) Pub. Date: Mar. 5, 2009

(54) POWER DEVICE AND OXYGEN GENERATOR

(75) Inventors: Bruce F. Monzyk, Delaware, OH (US); Paul E. George, II, Powell, OH (US); Christopher J. Pestak, Brunswick, OH (US); Jay R. Sayre, Columbus, OH (US)

Correspondence Address: FAY SHARPE LLP, 1100 SUPERIOR AVENUE, SEVENTH FLOOR, CLEVELAND, OH, 44114, US

(73) Assignee: BATTELLE MEMORIAL INSTITUTE, Columbus, OH (US)

(21) Appl. No.: 12/065,077

(22) PCT Filed: Aug. 31, 2006
(86) PCT No.: PCT/US06/34004

§ 371 Date: Sep. 11, 2008

Related U.S. Application Data
(60) Provisional application No. 60/713,079, filed on Aug. 31, 2005.

(51) Int. Cl. H01M 8/06; H01M 8/18; H01M 14/00; H01M 16/00; C01B 13/00; C01B 15/00; C25B 1/00

(52) U.S. Cl. 429/21; 429/17; 204/660; 205/455; 205/462; 205/464

(57) ABSTRACT

A system for oxygen, hydrogen and carbon mass regeneration and recycling for breathing, and fuel/energy generation purposes, especially for fuel cells and rocket motors, by combination and integration of a photoelectrolytically powered electrochemical and gas handling system with one or more fuel cells.

### PRIORITY CLAIM

This application claims priority to and extends the teachings and disclosures of the following applications: Provisional Application Ser. No. 60/358,448 for Development of Photolytic Pulmonary Gas Exchange, Bruce Monzyk et al., filed Feb. 20, 2002; Provisional Application Ser. No. 60/388,977 for Photolytic Artificial Lung, Bruce Monzyk et al., filed Jun. 14, 2002; Provisional Application Ser. No. 60/393,049 for Photolytic Oxygenator with Carbon Dioxide Fixation and Separation, Bruce Monzyk et al., filed Jun. 20, 2002; and PCT Application No. PCT/US02/24277 for Photolytic Oxygenator with Carbon Dioxide Fixation and Separation, Bruce Monzyk et al., filed Aug. 1, 2002; Provisional Application Ser. No. 60/404,978 for Photolytic Oxygenator with Carbon Dioxide and/or Hydrogen Separation and Fixation, Bruce Monzyk et al., filed Aug. 21, 2002; PCT Application No. PCT/US2003/026012 for Photolytic Oxygenator with Carbon Dioxide and/or Hydrogen Separation and Fixation, Bruce Monzyk et al., filed Aug. 21, 2003; and Provisional Application Ser. No. 60/713,079 for Closed Loop Oxygen Generation and Fuel Cell, Paul E. George II et al., filed Aug. 31, 2005.

The disclosures of the above referenced PCT applications (and if necessary their US non-provisional counterparts) and the disclosure of Provisional application having Ser. No. 60/713,079 are hereby incorporated by reference.

### STATEMENT OF GOVERNMENT RIGHTS

The invention was made under contract with an agency of the United States Government under NASA contract No. NNT04AA02C. The United States Government has rights in this invention.

### FIELD OF THE INVENTION

The present invention is directed to a compact power supply system integrated with a fuel generation/regeneration system that typically recycles C, H and O mass and where the energy for process is supplied externally. In the preferred version of the invention a photolytically driven electrochemical (PDEC) device accomplishes simultaneous oxygen production from water while fixing carbon from carbon dioxide and hydrogen from water into fuels, most preferably for fuel cells or rocket motors, and can be of caloric food value, and where the CO₂ and H₂O sources are derived by separation from to breathing atmospheres in confined spaces and/or fuel cell exhaust.

### BRIEF DESCRIPTION OF THE DRAWINGS

FIG. 1 is a schematic drawing of a broad overview of the invention showing major mass and energy sources and flows.

FIG. 2A is a schematic drawing of a typical flow through cell for PDEC. FIG. 2B is a schematic drawing of a typical PDEC unit for space suit applications.

FIG. 3 is a schematic drawing of a detailed layout for an integrated PDEC/Fuel Cell system.

FIG. 4 is a schematic diagram showing a cross sectional view of a typical polymer electrolyte fuel cell (PEMFC) according to one aspect of the invention.

FIG. 5 is a schematic diagram showing a cross sectional view of a typical direct methanol fuel cell (DMFC) according to one aspect of the invention.

FIGS. 6A and 6B are graphical illustrations of PDEC photocatalyst performance in Hasenbach photosynthesis test cells.

FIG. 7 is schematic diagram of PDEC cell internal flow for another aspect of the invention for fuel cell fuel regeneration and O₂ production. Typical design parameters for the cell are shown.

FIG. 8 is a schematic diagram showing a two-step process for fuel cell fuel regeneration according to another aspect of the invention. The process typically involves fuel cell spent fuel electrolyte photolytically powered electro-organic chemical reduction using anode products 2e− and 2H⁺ for each Mole of O₂ produced.

FIG. 9 is a schematic diagram of another aspect of the invention showing Stores, activities, and C, H, and O recycle. The figure further illustrates PDEC integration with fuel cells and fuel cell fuel regeration and related storage vessels.

FIG. 10 is a schematic diagram of another aspect of the invention showing a PDEC cell with a gas diffusion cathode. This allows the circulation of gas directly through the cell for removing excess CO₂ in air. Microporous hydrophobic polymers are typically used for the CO₂ selective film. A typical material is Teflon™. The process is a single step type design for carbon dioxide removal and fixation

FIG. 11 is a schematic diagram of another aspect of the invention showing a two-step process for carbon dioxide removal from a gas stream involving capture followed by fixation. A liquid scrubber is used for a fully liquid PDEC cell.

FIG. 12 is a schematic diagram of another aspect of the invention as applied to use with illuminated photocatalyst slurry, bed or gel, or films, rather than just films alone. The electrolyte is prepared using any readily reversible oxidizable/reducible inorganic or organic species or blend of species. Acidic ferric/ferrous electrolyte is shown in FIG. 12. Examples of other such systems are included elsewhere herein, for example cupric/cuprous, ferricyanide/ferrocyanide, alkaline solutions of nickel, hydroquinone/quinone, and the like.

### BRIEF DESCRIPTION OF THE INVENTION

Broadly, PDEC technology uses photolytic energy directly (unlike PV) to drive electrochemical reactions that can process CO₂ and regenerate oxygen in a confined space. Typical advantages include increased quantum efficiency, light weight, small size. While resources on the Moon and Mars are severely restricted, photons are abundant. Solar energy is available for 14 of the 28 day lunar cycle and can be generated using lamps during lunar nights and on Mars. PDEC applications include modular air regeneration systems that are used in spacecraft, lunar habitat modules, and spacesuits that have significant benefits such as reduced mass, reduced volume, reduced power. more easily scalable, and modular components that can be shared between systems. In addition, the system can greatly simplify the “logistics train” for exploration of Moon and Mars.

Generally, the embodiments according to the invention provide for breathing air in confined spaces by removal of CO₂, H₂O and impurities, and to adding oxygen; recycle of water; recycle of C, H and O; regeneration of fuel cell fuels; low electrical power for general controls, sensors, etc.; oxygen generation for fuel cells and breathing air. The systems can be compact, mostly solid state, integrated systems powered by lamps or direct solar energy.

Photolytic conversion takes place inside the PDEC cell where typically the majority of the power for conversion is derived from light input to the PDEC cell.

One embodiment of the invention includes a method for providing a human habitation in an enclosed space including:

A. providing an enclosed space for human habitation;
B. photolytically converting CO2 and/or H2O, wherein the CO2 and/or H2O are optionally at least partially generated within the enclosed space, to a product comprising one or more of a chemical, fuel, food, oxidant, and/or one or more intermediates for the same and providing at least a portion to the enclosed space;
C. producing energy, from one or more of the products of step B; and
D. recycling the spent reactants from energy production and/or from respiration to
step B. Typically the method includes CO2 and/or H2O of step B being at least partially from one or more of the following: respiration of an inhabitant, fuel cell exhaust, and reformer off gas. the product of step B may include one or more of the following: oxygenated hydrocarbon, hydrocarbon, carbohydrate, oligomer, polymer, hydrogen, oxygen, carbon, paraformaldehyde, and a chemical intermediate; ethylene and/or methane; formaldehyde, a trioxane, or sugar. C5 may be provided for conversion to C6 sugars. 11. A method for providing energy and reactants to an enclosed space comprising:
A. providing an enclosed space;
B. photolytically converting CO2 and/or H2O, wherein the CO2 and/or H2O are optionally at least partially generated within the enclosed space, to a product comprising one or more of a chemical, fuel, food, oxidant, and/or one or more intermediates for the same and providing at least a portion to the enclosed space;
C. producing energy, from one or more of the products of step B; and
D. recycling the spent reactants from energy production to step B.

Another embodiment provides for a method for providing a power source and maintaining a human breathing atmosphere in an enclosed space by the steps of:

A. providing an enclosed space for human habitation;
B. photolytically providing an oxidant, electrons/electrical current, and hydrogen ions,
C. Using these electrons and hydrogen ions for converting CO2, chemically oxidized organic or inorganic compounds, and/or H2O, wherein the CO2, chemically oxidized organic and/or inorganic compounds, and/or H2O are optionally at least partially generated within the enclosed space, to a product comprising one or more of a chemical, fuel, food, oxidant, chemically reduced organic or inorganic compound(s), and/or one or more intermediates for the same;
D. producing energy, from one or more of the products of steps B and/or C; and
E. recycling the exhaust materials from energy production and/or from human respiration to step B.
Typically the reduced inorganic compound is one or more of water,

### N2,

Fe(II), Pb(II), Mn(II), V(III), Ce(III), Cr(III), TI(I), Hg(I)22+, Cu(I), V(IV)O2+ ion, V(V)O2+ ion, and/or other metal ions, including oxo-containing ions, alone, aquated, chelated, or complexed,
sulfate, sulfite, thiosulfate, dithionite, sulfide, ions, and/or other reduced form of sulfur or S-containing peroxides
borate ion, boron hydrides, cyanoborohydrides, and/or other reduced form of boron or B-containing peroxides
silver, nickel, copper, gold, iron, cadmium, lead, zinc, manganese, or other metal or metal mixture,
ammonia, ammonium ion, hydrogen cyanide, hydroxylamine, hydrogen peroxide or a metal peroxide, bromate ion,
MnO2, ZnO, InSnO (ITO), As2O3, manganate, FeO, PbO, SnO, and other redox active solid metal and metalloid oxides
hypochlorite, iodate ion, I2, hydrazine, chloride ion, bromide ion, iodide ion, chlorous acid, clorate ion,
N2O, N2O4, H2N2O2, nitrous acid, NO,
elemental sulfur (S, S8), elemental phosphorus (P, P4), hypophosphite ion, phosphonate ion, phosphine (PH3) and phosphine derivatives,
ferrocyanide,
and the like, and mixtures of these materials.
21. The method according to claim 12, wherein the enclosed space is a spacesuit, a space station, a lunar building or living module, or enclosed colony, a mars building or living module, or enclosed colony, a near earth or interplanetary space ship, a lunar, mars, or planetary land rover, an underwater, under sea, unit, a underwater rescue unit, or a terrestrial survival unit.

In other embodiments the inorganic compound is one or more of Hydrogen peroxide,

Fe(II, III,VI), Pb(IV), Mn(III,IV,V,VI), V(IV, V), Ce(IV), Cr(VI), TI(III), Hg(II), Cu(I,II), Ag(I,II), Ni(II, III, IV), Au(I, III), Cd(II), Zn(II), V(IV)O2+ ion, V(V)O2+ ion, and/or other metal ions, including oxo-containing ions, halide complexes, pseudo halide complexes, hydroxide complexes, alone, aquated, chelated, or complexed with ligands,
persulfate ion, and/or other oxidized forms of sulfur or S-containing peroxides perborate ion, and/or other oxidized forms of boron or B-containing peroxides hydroxylamine, nitrite ion, nitrate ion, cyanogen, H2N2O2, N2O4, nitrous acid, nitric acid,
hydrogen peroxide or a metal peroxide such as barium peroxide, MnO2, ZnO, InSnO (ITO), As2O5, permanganate (MnO4-), Fe3O4, KOH/K2FeO4 blends, LiOH/Li2FeO4 blends, other blends of ferrate(VI) involving alkali and/or alkaline earth ions, PbO2, SnO2, and other redox active solid metal and metalloid oxides
bromate ion, hypochlorite, periodate ion, I2, Br2, chlorous acid, clorate ion, phosphonate ion
N2O, N2O4, H2N2O2, nitrous acid, NO,
Ferricyanide ions,
and the like, and mixtures of these materials with any metal ion or hydrogen ion or oxide/hydroxide ion required for an over all neutrally charged material.

Another embodiment provides for an apparatus for fuel regeneration and oxygen production including:

A. a PDEC cell comprising a photo anode that absorbs light and carries out oxidation; and a cathode, optionally separated by a separator or membrane to form an anode and cathode compartment; and
b. a fuel cell having its exhaust connected to the PDEC cell, wherein the exhaust water flows to the anode side and oxidized or spent fuel flows to the cathode side of the apparatus.

A yet further embodiment includes apparatus for fuel regeneration including:

A. a PDEC cell having an inlet and an outlet and a photoanode and a cathode, optionally separated by a separator or membrane to form an anode and a cathode compartment; wherein the cathode is permeable to gas; and
B. a fuel cell connected to the PDEC cell, wherein spent fuel is sent to the PDEC cell for regeneration. IN some embodiments there is a gas separator for oxidized fuel between the exhaust of the fuel cell and the PDEC cell wherein a basic material is contacted with gaseous spent fuel.

An additional embodiment includes apparatus for regenerating spent fuel using photolytic energy including a PDEC cell having walls transparent to light and having an inlet and an outlet, and a filter in the inlet and outlet, forming a chamber; and

B. a photocatalyst slurry within a chamber. The apparatus may include
C. a fuel cell, optionally having a gas fuel exhaust separator between the PDEC cell and a fuel cell, and wherein the outlet of the fuel cell is connected to the inlet of the PDEC cell.

Various aspects of the invention include:

An integrated system for at least C, H, and O mass conservation (“atom balance”) in confined environments without interaction with the environment other than energy {light (solar, lamp, laser), wind, hydroelectric, etc.}. One aspect of the invention provides for an integrated system for C, H, and O mass conservation in confined environments without interaction with the environment other than light energy and in which the conserved mass is recycled and is a food or a fuel.

An integrated system for C, H, and O mass conservation in confined environments without interaction with the environment other than energy in which the conserved mass is recycled and is a food or a fuel and where the system is flexible with respect to the fuel produced.

An integrated system for C, H, and O mass conservation in confined environments without interaction with the environment other than energy in which the conserved mass is recycled and is a food or a fuel and where the system is flexible with respect to the fuel produced and where the fuel has multiple uses.

An integrated system for C, H, and O mass conservation in confined environments without interaction with the environment other than energy in which the conserved mass is recycled and is a food or a fuel and where the system is flexible with respect to the fuel produced and where the fuel has multiple uses including as a fuel cell fuel, a rocket fuel, and/or a food.

An integrated system for C, H, and O mass conservation in confined environments without interaction with the environment other than energy in which the conserved mass is recycled and is a food or a fuel and/or where the system is flexible with respect to the fuel produced, and/or where the fuel has multiple uses, and/or where the fuel processing includes a reformer.

An integrated system for C, H, and O mass conservation in confined environments without interaction with the environment other than energy in which the conserved mass is recycled and is a food or a fuel and/or where the system is flexible with respect to the fuel produced, and/or where the fuel has multiple uses, and/or where the fuel cell is one or more of the type solid oxide fuel cell, PEM-based H2/oxygen fuel cell, general reformer, and/or a Microtech™ reformer.

### DETAILED DESCRIPTION OF THE INVENTION AND BEST MODE

This invention provides a unique integration of three technologies that provide potential for use in the human exploration of the Moon and Mars, industrial work in confined or isolated locations such as in mining, in public service in fouled air environments such as fire fighting of buildings and forests, and in rescue, and for use in under water activities such as in submersible rescue vehicles, and the like. The first technology Photolytically Driven Electro-Chemistry (PDEC) technology, shows promise for any application that requires oxygen (O₂) regeneration for fuel cells, rocket propulsion, or maintenance of breathing atmospheres and management of carbon dioxide (CO₂) within a closed environment such as a confine space for working such as space craft, moon and Mars facilities and vehicles, submarines, underwater rescue vehicles and personal breathing devices for fire fighting and rescue, mining accidents, under water individual breathing devices, robotic aircraft, and the like. PDEC technology coupled with fuel cell technology can be the foundation for the next generation of life support systems, especially for confined environments, for a wide range of applications such as compact energy systems for robotic aircraft, spacesuits, to space vehicles, submarines, aircraft, mining environments, battlefield vehicles and portable breathing systems for emergency responders, and the like. PDEC uses photolytically powered fuel regeneration to eliminate a least a portion or size of fuel tanks and refueling requirements, and thereby achieving substantial increases in system power density when rated over extended periods, or achieved by small or lightweight devices.

The second technology of the integrated compact power system involves fuel cells. Applicable fuel cells include those operating at <300 C, for example those using Polymer Electrolyte Membranes (PEM) fuel cells, and the high temperature Solid Oxide Fuel Cells (SOFC), and the like. Such fuel cells consist of PEM materials coated on both sides by catalyst, most preferably Pt catalyst. Solid oxide fuel cell stacks, Membrane Electrode Assemblies (MEA), separators, catalysts and sulfur controls are useful.

The third major component of the invention involves one or more reformers, preferably a compact microchannel reformer capable of processing a wide range of C/H or C/H/O containing fuels into a fuel stream for the fuel cell or used for rocket fuel.

As an example, a state-of-the-art 2.5 kWe PEM fuel cell Auxiliary Power Unit (APU) packaged unit was developed for the U.S. Army Bradley Fighting Vehicle (BFV). The BFV APU runs on synthetic diesel that is reformed to deliver pure hydrogen to the fuel cell. The reformer uses microchannel technology to achieve dramatic reductions in the mass and volume of the APU.

C, H, O recycle, fuel reformer, and fuel cell integrated unit operations can play important roles in a lunar or Mars transit and surface system hardware architecture, providing efficient use of the precious C, H and O resources that must be transported into space from Earth using expensive rockets to Mars or the lunar surface. In addition, with proper integration, this technology combination has been discovered to create a synergistic, ultra-efficient architecture for power and life support that greatly reduces the logistic re-supply requirements for e.g. a lunar outpost and many other confined and/or remote environments. This application describes embodiments for such an architecture.

### EXAMPLE 1

### Lunar Surface Architecture Material and Energy Requirements

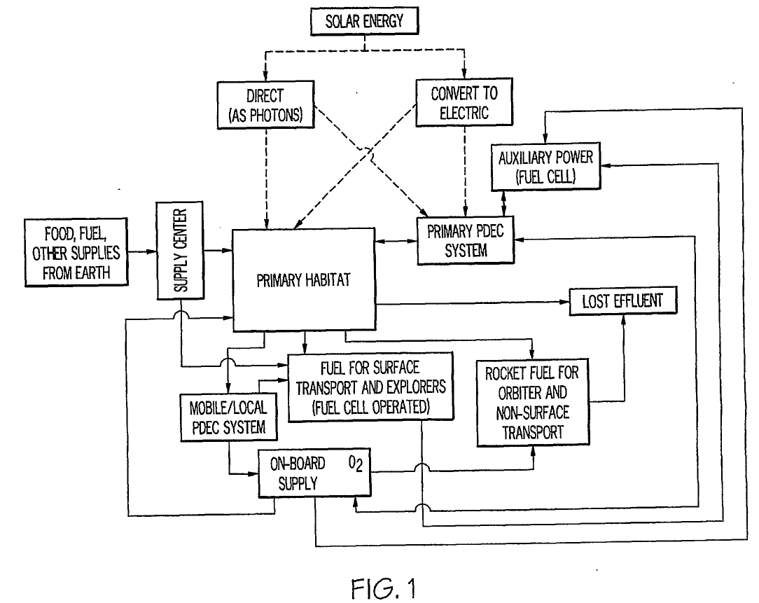

FIG. 1 shows schematic drawing of one embodiment of a lunar, Mars surface or interplanetary spacecraft habitat and supply depot that appear useful for these or other applications such as submarines, aircraft, underground mining, and the like. As an example, as applied to lunar or Mars surfaces, key features are life support within the primary habitat and support for mobile devices, including surface to orbit as a part of surface to earth transport. The core earth to lunar surface transport requirements are essentially energy in special forms (food and water for crew, oxygen for crew and specialized fuels for surface and orbital transport) in addition to scientific support systems. Energy is available on the lunar surface in the form of sunlight. One objective PDEC/Fuel Cell embodiments disclosed herein is to at least partially replace transported special-form energy with local energy and provide for efficient storage of energy for use during dark periods. As described below, the PDEC system enables the efficient restructuring of carbon containing molecules to higher energy levels; for example, transforming carbon dioxide into simple hydrocarbons such as methanol, trioxane, paraformaldehyde, ethanol, and others (Table 1). Additional specialized chemical synthesis enabled by advances in microtechnology chemical processing technology can further enhance the fuels by on-site processing. Thus, the PDEC system can be considered as a bridge between atmospheric cleanup within the primary habitat and specialized energy requirements (e.g., fuel cell powered surface transport). In addition, the PDEC system offers a means of storing solar energy for use in fuel cell power plants during the portion of the lunar cycle when the primary habitat is not illuminated by the sun. The PDEC system can also first-step input for additional fuel upgrades (to kerosene like fuels for example) that may have higher energy density and thereby provide better safety, longer missions, and more compact storage when coupled with reformer equipped fuel cells.

As shown in FIG. 1, an onboard mobile PDEC system may recapture the materials effluent from a fuel cell (direct methanol fuel cell or reformer based) and return them to the base habitat (where the primary energy source is located) for further processing. It may further increase mission length by providing on-board atmospheric clean-up using power from the fuel cells—energy that has been stored in a higher energy content fuel earlier. The material from the orbital rockets is lost and must be re-supplied from earth. However, a PDEC system enables the re-supply to focus on bringing material to the surface in the most specialized and useful form (e.g. food) that is subsequently reprocessed to useful fuels.

### Description of PDEC-based Closed Loop Life Support System

PDEC technology developed to date can meet the mass, volume, and power consumption design constraints associated with a spaceflight system.

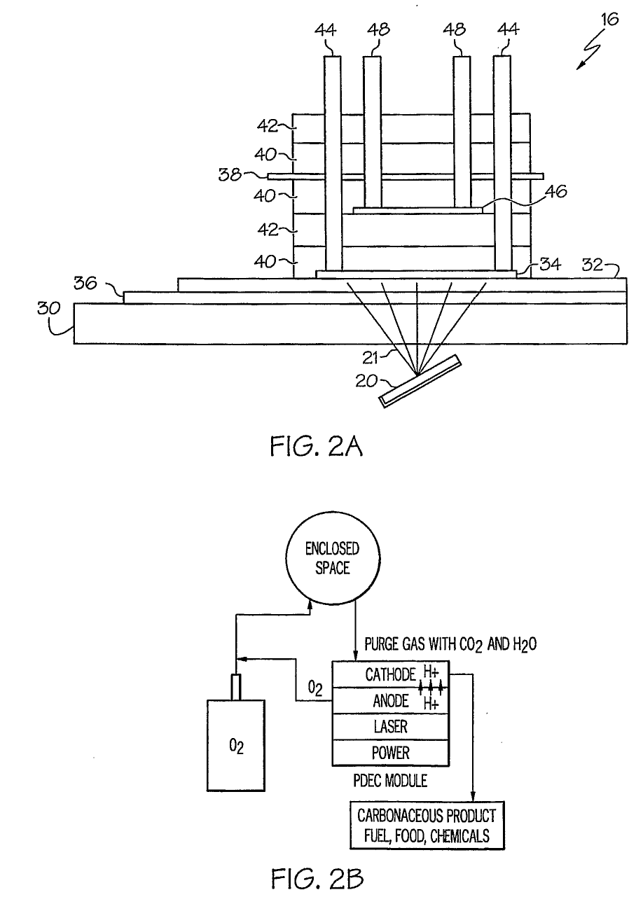

A typical flow cell is found in FIG. 2A. The present PDEC technology mimics the photosynthesis process occurring in green plants, using light energy to simultaneously generate oxygen and electrical energy while removing CO₂ and water from the breathing atmosphere. The system can be sized to accommodate the maximum expected CO₂ production rate by the astronaut of 50 mg/s and potentially close the mass balance on the respiration gas maintenance cycle.

FIG. 2A shows one of the flow-through embodiments of one embodiment of a photolytic cell 16 of the present invention. In this flow-through cell embodiment, the following main components of the photolytic cell 16 are assembled, i.e. a conductive coating of vacuum deposited Ti metal 36, a coating of adherent TiO₂ (anatase) 32, an optional MnO₂ particulate layer 34. A UV laser light 20 was shown on the transparent glass or quartz substrate 30 so to initiate the reactions.

In this regard, the photolytic cell 16 of FIG. 2A includes a transparent window 30 or wave guide for the entry of light energy in the form of photons 21 from a light source 20 such as an ultraviolet laser light. On one side of the glass slide is an anode conductor layer 36, such as titanium (Ti) metal film. Attached to the anode conductor layer 36, is a layer of a light activated catalyst 32 such as anatase (TiO₂). An optional catalyst layer 34, such as manganese dioxide, is adjacent to the light activated catalyst layer 32. The photolytic cell 16 includes one or more layers of silicone gaskets or spacers 40 and an acrylic housing 42. A pair of anolytes 44 (in/out) is connected to the light activated catalyst layer 32 or optional catalyst layer 34 and extend through the photolytic cell 16 away from the transparent window 30. The photolytic cell 16 further includes a cation exchange member 46, such as a NAFION® membrane from DuPont. A pair of catholytes 48 (in/out) is connected to the cation exchange member 46 and extends outwardly through the photolytic cell 16 generally away from the transparent window 30. The photolytic cell 16 further includes a cathode layer 38, such as Pt foil, adjacent to the cation exchange member 46. The operation and use of this embodiment of the invention is more particularly described below.

FIG. 2B illustrates an embodiment for a closed loop breathing system for a spacesuit. For the spacesuit application, the system would use a compact, portable laser light source that would require only electrical power. Thus, the spacesuit system does not require ambient light to operate. However, the spacesuit, space vehicle, rover, habitat module, and the like can be configured to use ambient light as the energy source. Because the preferred system does not use a sorption canister, CO₂ will not be vented to the outside environment and resources are conserved. The system appears applicable to: 1) spacesuits, pressurized rovers and habitat modules for the surfaces of the Moon and Mars, 2) orbiting and in-space transfer vehicles, and 3) a lunar or Martian Lander. The system also has great potential as a backup system for a Crew Exploration Vehicle (CEV).

A breathing atmosphere in a closed environment such as a spacesuit, space vehicle, lunar rover, or lunar habitat module can consist of blends of oxygen (O₂), water (H₂O), CO₂, and inert gases, with the exact ratio and the precise mass a function of the atmospheric pressure inside the closed environment. Expelled breathing atmosphere within the closed environment, enriched in CO₂ and reduced in O₂, is circulated to the breathing atmosphere regeneration system to capture the CO₂ and water vapor and to separate them from the O₂ and inert gas components. Simultaneously, O₂ is generated and reintroduced into the breathing atmosphere. The output of the system is a refreshed breathing atmosphere that can be delivered to gas storage and then released on demand.

The fully scaled breathing atmosphere regeneration system can be sized to achieve a rate of CO₂ removal from the helmet equal to the metabolic production rate of CO₂, measuring a mean of 25 mg/s, with a minimum of 8 mg/s and a maximum of 50 mg/s. The fully developed system can be targeted to consume less than 50 watts electrical power and be able to operate for extended periods, well beyond the 8-hour requirement currently envisioned for spacesuit systems.

In addition to providing an efficient method of breathing-atmosphere regeneration, the effluents output by the system can be captured for reuse. The CO₂ and H₂O that are separated from the breathing atmosphere can be chemically converted into oxygen and alcohols that can be used as feedstock for a PEM fuel cell. Methanol and ethanol are typical and likely outputs of the air regeneration system since these fuels have the potential for multiple uses on the lunar and Martian surface as feedstock for a fuel cell and as fuel for a rocket. This carbon re-use feature enables true closed-loop recycling of precious resources and greatly reduces the cost and complexity of the logistics necessary for space exploration.

The PDEC-based system can further enable human space exploration, greatly surpassing the capabilities of any existing technology or system currently available. The system is expected to continuously regenerate a breathable atmosphere without the need for LiOH canisters or other absorbers that have limited life and create major logistics problems due to the need to constantly re-supply them. Any requirements associated with the pressure and composition of the outside atmosphere are obviated, because the system eliminates the need to vent CO₂ gas to the outside environment.

### Description of Fuel Cell System

Fuel Cells are essentially electrochemical oxidation devices that directly convert the released energy from oxidation of a fuel into direct current electrical power. Fuel Cell power systems include the fuel cell stack proper along with the supporting controls and hardware, including power management subsystems. While there are a variety of possible systems, all have in common that the fuel, which actually reaches the fuel cell, must be appropriate for the type of fuel cell. For PEM, the fuel must be a hydrogen rich gas (preferably pure hydrogen) with minor amounts of water present, but no CO content as CO poisons the anode catalyst in the fuel cell (the poisoning is partially reversible under some conditions). For direct methanol fuel cells, a clean methanol/water mixture is typically used. Both require an oxidizer —which is usually air or some mixed gas with significant oxygen content (e.g. the breathable atmosphere within the lunar habitat.) Pure oxygen fuel cells are possible, but PEM and direct methanol fuel cells are usually operated on a mixed gas to avoid premature degradation of the electrolyte membrane.

PEM fuel cells are scaleable from a few watts to 100's of kilowatts with the most common commercially available sizes usually in the 3 to 15 kW range for general purpose and auxiliary power and in the 50 to 250 kW range for surface vehicle propulsion. Many of the commercially available PEM fuel cell systems operate on bottled hydrogen or other stored hydrogen sources. For PEM fuel cells to operate on more complex fuels, a fuel reformer is required to convert the complex fuel into hydrogen and benign diluents direct methanol fuel cells are used for applications requiring less than 1 kW, usually less than 200 W, where the overhead burden of a reformer and its support hardware is undesirable. direct methanol fuel cells typically have lower power density than PEM fuel cells, have shorter life, and are more expensive on a per kilowatt basis. Nonetheless, they are attractive in the low power range useful for personal power and instrumentation.

### Integration of PDEC-based Closed Loop Life Support System and PEM Fuel Cell System in a Lunar Architecture

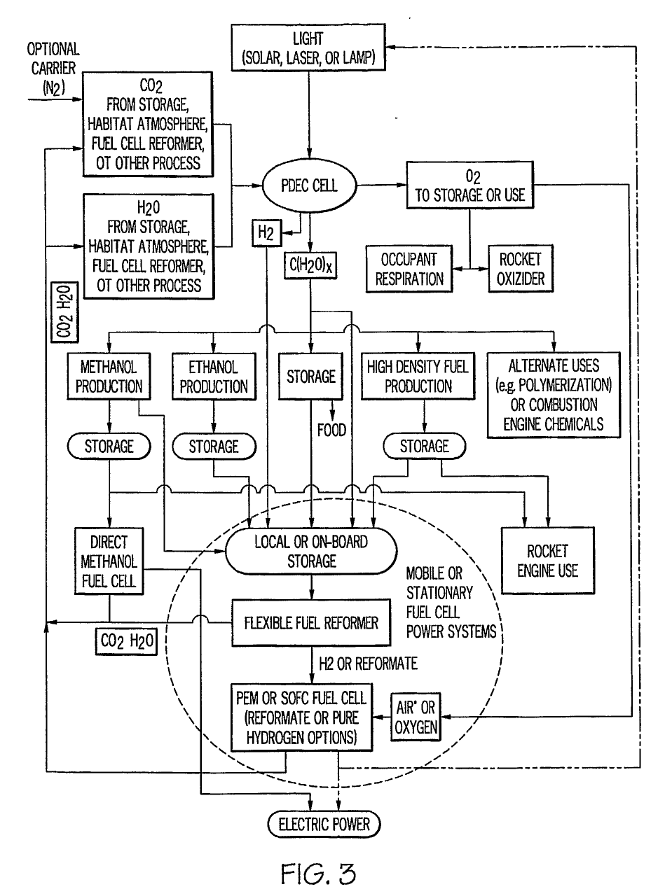

FIG. 3 is an overall schematic sketch of how a PDEC system might be combined with PEM and direct methanol fuel cell systems to create an ultra-efficient integrated system for life support and power in a lunar habitat and exploration application. As described previously, the PDEC system provides an efficient means to store energy within simple hydrocarbon molecules (usually methanol or formaldehyde). These molecules are easily stored in liquid form and can be further processed, if required, into more complex fuels.

The embodiment shown in FIG. 3 assumes that there are a variety of applications for electric power produced by fuel cells. Direct methanol fuel cells typically provide personal power for outside-habitat excursions as well as low power for instrumentation within and outside the base habitat. PEM fuel cells typically power surface vehicles, high power instrumentation, and critical power systems within the habitat. Typically multiple fuel cells within the habitat are used that use a common fuel. From a safety and convenience standpoint, the common fuel would preferably have high volumetric and mass energy density and be safe to handle (non-toxic, non-volatile, low-pressure containment.) Hence, the schematic envisions post-PDEC processing to convert formaldehyde (the most convenient PDEC product) into more complex fuels such as synthetic kerosene—primarily parafinic hydrocarbons. The higher energy density fuels would be preferable for extended missions and long periods of dark. Since the lunar night is of the order of 14 days long and the need for power can be greater during the night than the day, a significant amount of fuel must be stored during the lunar day.

Various aspects of the invention can provide for reuse of C, H and O during extended manned missions to the moon, and especially Mars; revitalization of breathing air for confined spaces; oxygen supply, CO₂ removal, RH control, control of impurities; water recovery and purification; fuel cell fuel regeneration; reduction of food mass per crew; and mass recycle system be capable of intermittent operation and be of light weight and compact design. The present invention can provide this by a regenerative life support system based on photolytically driven electro-chemistry (PDEC). The PDEC system can provide an integrated system for recycling O, H and C from spent breathing air, water and fuel cell fuels. In addition to the fuel aspects, the PDEC system separates oxygen for multiple uses, including use in the fuel cells—either as pure oxygen or after dilution with some of the inert gases that would typically be found in the effluent from the fuel cell and/or fuel reformer system.

FIG. 3 shows that fuel (and by implication oxygen) may be used in rocket engines for transport between the surface and an orbiting platform or re-supply ship from earth. Although methanol may be used for rocket fuel in this context, if sufficient energy is available from the solar source to upgrade the fuel to a kerosene or similar fuel, rocket performance and carrying capacity can be enhanced.

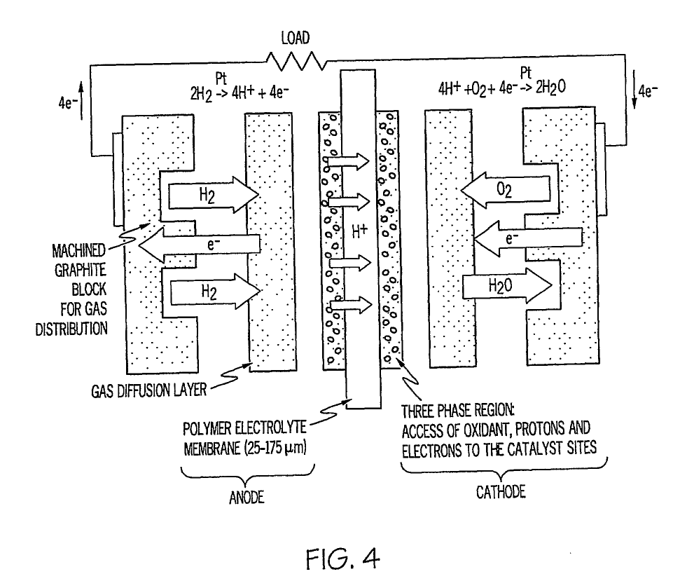

Referring now to FIG. 4, this figure illustrates the operation of a typical PEM fuel cell.

### Underlying Chemistry of Proposed Mass and Energy Balance

The following section provides an overview of the fundamental chemistry that is the foundation for the integrated PDEC/Fuel Cell system.

PDEC-Based Embodiment for the Fixation of CO₂, with Capture and Recycle of H₂O and Production of oxygen:

Objectives are to capture O and H from expired CO₂ and H₂O, minimize losses of O and H to C, or form a reusable form of C containing O and/or H. Therefore, propose a 4-electron reduced generalized oxygenated hydrocarbon product of CO₂ accomplished using a PDEC cell, i.e.

yhυ+xCO₂+xH₂O→{C(H₂O)}x+xO₂ (1)

Where hυ represents photolytic energy (photons). This reaction can be simplified to,

y/xhυ+CO₂+H₂O→1/x{C(H₂O)}x+O₂ (2)

Where the CO₂ and H₂O arise from fuel combustion, for example from a fuel cell device, or from the breathing air from the confined space used by to the person, animals, plants or crew. For example, such atmospheres are available from the gas expired from an astronaut in a confined system such as a Mars Lander or Mars Rover vehicle, or from miners in closed sections of coal mines during mine accidents, from firemen suited up and located within burning buildings, abandoned well rescue, and the like.

### Fuel Cell Production of CO₂ and H₂O:

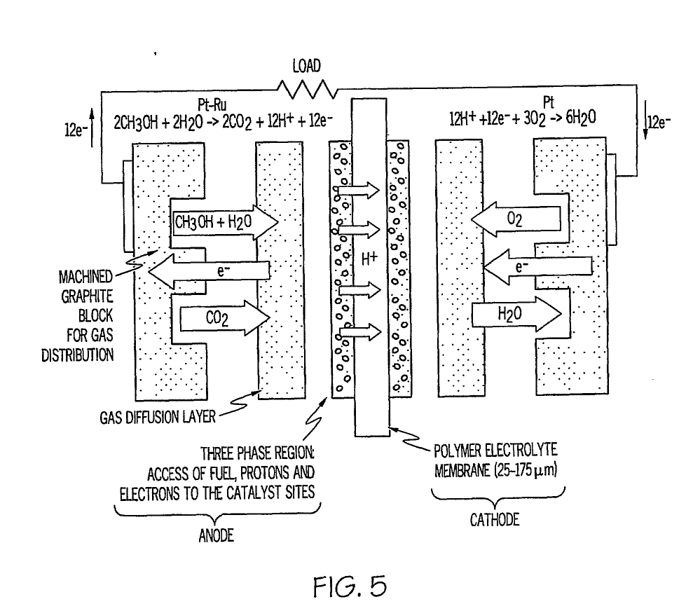

Referring now to FIG. 5, this figure is a schematic drawing of a typical direct methanol fuel cell. CO₂ and H₂O gases are also the exhaust gases of a fuel cell operated using methanol and O₂, or the above C(H₂O)x generalized oxygenated hydrocarbon fuel and O₂ as follows:

### Emerging Methanol Fuel Cell:

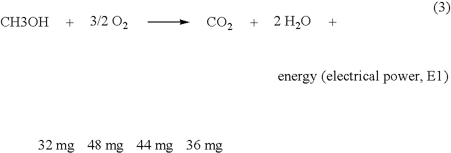

Typical General Fuel Cell Description for PDEC for one embodiment of the invention:

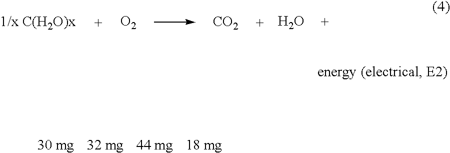

### Benchmark Technology:

### Breathing Air Maintenance:

Current CO₂ removal baseline technology from breathing gas in confined space utilizes the LiOH expendable sorbent as follows:

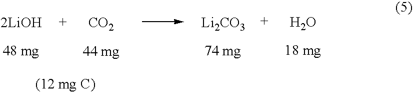

Therefore, about as much lithium hydroxide needs to be carried into space as the CO₂ produced by breathing and the fuel cell should the CO₂ be combined with the breathing gas and the oxygen and inert gas(es) are to be collected and recycled. Although thermal calcination often liberates CO₂ from metal ion carbonates and regenerates the metal oxide for recycling, in the case of lithium carbonate, the calcination temperature at 760 Torr is about 1310° C., prohibitively high for most furnace materials and a difficult operation even terrestrially. Hence, there is interest in alternative CO² removal technologies for breathing atmospheres in confined spaces for the Moon and Mars missions as the extended length of time for these trips would require enormous LiOH canister supplies. At $35 k/lb for low earth orbit, the costs appear prohibitive. What is more, in a critical problem, the C, O and some of the H²O involved in LiOH sorption technology are lost from reuse.

### H₂/O₂ Fuel Cell:

H₂/O₂ fuel cell chemistry involves the combination of these gases at warm conditions, for example using a PEM-based cell with Pt catalyst, to release water vapor and electrical power according to the reaction,

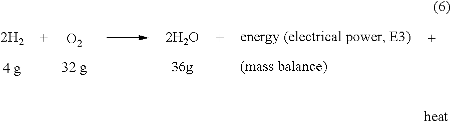

Respiration from Food:

For certain applications, such as in interplanetary travel or onboard military submarines in a stealth environment, the C, H and O cycle also needs to include food respiration. Hence consideration of CO₂ and H₂O produced from crew food consumption and expiration is needed to close the mass balance on the breathing atmosphere maintenance with respect to these major gases. Food respiration using the general designation of {C(H₂O)}Z to represent carbohydrate energy food, is described by:

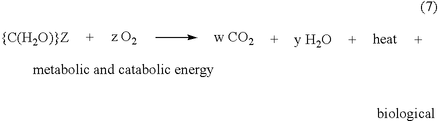

Note that the actual respiratory coefficient, determined from NASA missions, about 0.87 mole CO₂ produced per mole O₂ consumed, i.e. w=0.87 for z=1.0, due to metabolic processing (biological fixation), and liquid and solid waste formation (biological catabolic processing).

### SUMMARY

The present application discloses a combination of a PDEC photoelectrolytic system with fuel cells to reduce earth-to-lunar transport burden. The environmental benefits of minimizing the effluent into the lunar environment or the use of other wastes streams besides respiration (such as urine) to provide energy and/or atoms (H, C, and O) for energy storage and transport are not discussed. The specifics of the fuels to be produced or an overall look at the energy efficiency of such an approach have also not been evaluated here. Because of the high cost of transport of energy to the lunar surface, the use of the available local energy source —solar energy —to reduce the transport burden is clearly highly desirable, particularly as mission length extends. Fuel cell systems, being clean, efficient and quiet are ideal for electrical energy production.

The PDEC technology is potentially the key to enable what can be viewed as an atom balance on the lunar surface. That is, once the habitat has been initially supplied, there will be possible to at least partially rely on carbon and hydrogen atoms to store and transport the required energy thus reducing the need for re-supply. There is of course material lost in rocket propulsion and the inevitable loss due to leaks and purges. To the extent possible, the re-supply should bring replacement atoms in the highest value form factor—probably food.

PDEC Cell Design Description for fuel cell fuel regeneration (Fuel Cell Fuel Regeneration)

Certain metal oxides (MO) are known to efficiently convert photons of certain energy ranges into high energy excitons leading to useful charge separation via when the MO is a semiconductor, i.e.,:

hν+MO→MO(h+)+e−scb (8)

Where hν=light/photon energy, e−scb=electron in metal oxide semi-conductor band. This charge separation is a key step in the energy transduction that is to provide the fuel cell fuel regeneration process. The semiconductor band, in these cases, represents the well-established electronic structure of semiconductor materials, which are based in a combination of extended unoccupied molecular orbitals of low energy. Hence, the fundamental photolytic process is considered evolutionary for PDEC technology. For good quantum efficiency and ruggedness, the metal oxide chosen can be micron-thin films of TiO₂(anatase), ZnO, WO₃, or other robust ceramic metal oxide materials deposited on conducting surfaces (to enable removal of e−scb) configured on light transparent surfaces. Advantage can be taken of the increases in quantum yields and absorption spectrum bandwidth that have recently developed (and continue to be developed) in the fields of optics and electronics. Many refinements are possible using new and evolving modifications of the metal oxide materials. Dopant additives, such as trace metal ions, can be added to the metal oxide matrix to broaden the wavelengths for energy absorption (spreading the band gap energy over a broader range), allowing more complete use of the solar emission spectrum, and/or increasing quantum efficiency for charge separation {φ(e−scb)}.

In reaction (8) the symbol MO(h+) represents the metal oxide location that lost the electron upon photon absorption {formed from the exciton when the e−scb has been removed via the semiconduction band (see below)}, which is therefore electron deficient and energetic. This location is referred to as a “hole”. This charge separation is critical to efficient capture of photolytic energy in a useful versatile form and is believed to occur as follows. On absorption of quanta of light with sufficient energy, a ground state electron put into an excited electronic state. (More accurately the molecular ground state absorbs energy and, thereby, becomes an excited electronic state, however, it is far easier to visualize the location of electrons than the energy states of crystals). For the metal oxide candidates mentioned, this electron is a non-bonding electron on an oxide ion otherwise bonded to the metal ion as a part of a crystal lattice. When unassisted by dopants and/or dye sensitizers, this electronic transition normally corresponds to roughly the 350-500 nm region of the electromagnetic spectrum. The e− being excited into the semiconductance band (scb) of the MO semiconductor thereby become distributed over the entire crystal lattice of the metal oxide and, therefore, are no longer localized on the source oxide ion. Distribution away from the MO(h+) site prevents recombination. With dopants and/or dyes. This wavelength window broadens to about 750 nm and potentially 7-10% quantum efficiencies.

The energy represented by MO(h+) has been the key focus of this actively developing field of applied photochemistry and being used for the oxidative destruction of environmentally pollutants in ground waters by UV irradiation of anatase TiO₂ powder. However, the present invention includes using the energy of MO(h+) and the e−scb to drive the formation of useful products. For the compact energy device objective, these are to be FRFR and compressed oxygen with the approach described below.

The first step in fuel cell fuel regeneration is the formation of oxygen and the reducing agent. the invention provides for useful solar-powered electro-organic chemical reductions. Oxidized fuels can be organic compounds or CO₂ gas. As per Reaction (1) below O₂ generation, CO₂ capture, CO₂ chemical reduction, and organic and inorganic chemical reductions, in general, can be surmised. In addition some electricity generation is possible from this one photocatalyzed system (PDEC). Although this concept is fundamentally opposite to the polluted water treatment applications for UV irradiated titania mentioned above, the preliminary results to have been very encouraging.

Reaction (9) illustrates the oxygen producing reaction.

MO(h+)+H₂O→MO+2H++½O₂(g) (9)

In this reaction the ground state MO is reformed and ready for the absorption of another photon by Reaction (8). Hence, by combining Reactions (8) with (9), it is clear that the metal oxide is a photo-catalyst for direct oxygen production from water (Reaction 10).

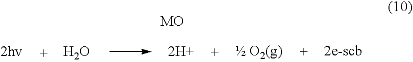

Reaction (10) achieves formation of oxygen without having to first generate electricity and then using the electricity to electrolyzing water. Hence, PDEC, unlike conventional photovoltaics (which first produce electricity) offers a new approach for using photolytic energy with high efficiency and with point-of-generation chemical separations and pressurizations. Therefore, PDEC appears novel in that it forms useful products directly upon photon absorption, as in the case of PS-II. That is, oxygen, H+ ions, and electrons/electrical current are produced directly and omitting at least one-step in solar energy utilization. This approach enhances the ability to affect high yielding energy transduction in the form of photolytic/chemical conversions and simplifies system complexity by provided more than one chemical conversion at a time.

This new proprietary photolytic process is referred to as photolytically driven electro-chemistry (PDEC) as indicated by the photolytically powered oxidation-reduction chemistry represented by Reaction (10). Unlike photolytic water splitting, the oxygen is not produced and mixed with H₂, thus avoiding the production of an explosive mixture.

### Photo-Catalyst Performance Mechanism and Description of Future Development Potential

Of the above-mentioned catalysts, the TiO₂ (anatase) catalyst film, optionally coated by a second metal catalyst such as manganese dioxide to promote fast oxygen gas formation rate through active oxygen disproportionation and gas bubble formation and release, can be one tested system and can be used here to illustrate the oxygen gas generation technology approach.

When TiO₂ catalyst is used, the photon-titania interaction is the first step in the ultimate formation of oxygen and regenerated fuel cell fuel. It is known that surface hydrated/hydroxylated particulate TiO₂ (anatase) solid (Ti(IV)O₂(a)-OH₂ or Ti(IV)O₂(a)-OH), is an efficient UV light (hν) absorber at wavelengths <390 nm (>3.2 eV). Photons absorbed at this energy quickly produces the critical “active oxygen” formation (the hole, h+, referred to above) from sorbed water and hydroxyl groups in high yield. The initial step in photon absorption is the symmetry allowed (highly favorable) ligand-to-metal charge transfer reaction (CTM←L) illustrated as follows:

{Ti(IV)O₂(a)-O=}+hν→{Ti(III)−·O—}* (11)

Where the {Ti(III)−·O—}* represents the electronic excited state produced immediately upon photon absorption at one site within the crystal. The catalyst film thickness will be chosen enough to insure ˜100% of light absorption in this manner. For most materials, such excited states immediately lose their energy by vibronic coupling, thereby returning the chromophore to its ground state with only a slight warming of the surroundings. However, for semiconductor materials where such ligand→metal transitions occur, the excited electron is not localized on the metal ion (formally designated as TiIII in Reaction (11) but rather on a molecular orbital delocalized over many atoms (known as a conductance band, or more precisely a “semi-conductance band” or escb−). The difference in the to molecular energy state corresponding to ground and excited states in these cases designated the “band gap” energy. The band gap energy for anatase TiO₂ is 3.2 eV and corresponds to photon energy of 389 nm. Higher energy photons are still readily absorbed since many vibrational states overlay the major electronic states involved, giving an apparently smooth absorption band of at least 350-389 nm. Dye sensitizers and dopants can be added to expand this absorption band to include essentially all of the solar spectrum transmitted by earth's the atmosphere with wavelength <750 nm.

Critically, when the photon is absorbed as just described above, the net effect of exciting the electron into the semiconductor band of the TiO₂ is equivalent to photolytically caused charge separation, i.e., a direct chemical change or energy transduction. Charge separation represents a high-energy state of materials from which useful work can be accomplished. In the proposed work, we plan to use this charge separation to effect useful chemical changes, that is, the simultaneous regeneration of fuel and the production of O₂ oxidant using solar energy. This can provide a compact, long-lived power system to enable robotic units very long extended missions (years) and can achieve the required very high annualized power densities due to specific power enhancements (and also due to the requirement for only small fuel tanks). The fundamental science and technology of how this is to be provided is now described. The oxidant (O₂) generation approach will be described first and then fuel regeneration. It is important to remember that the PDEC technology can provide oxygen and fuel cell fuel regeneration simultaneously using photolytically energized processing. The electrons and hydrogen ions released from water during the oxygen production operation can be used to reduce the oxidation state of an oxidized organic compound (the fuel cell fuel) at a cathode by electrochemistry. An evolutionary technology approach can be used to accomplish long-lived fuel cell fuel regeneration capability, hence substantially reducing the risk of achieving the ultimate power system goals while adding substantial flexibility of design. These and other features of the PDEC fuel cell fuel regeneration process will become apparent from these descriptions.

### Chemistry Basis for the Photolytic Generation of Pure, Pressurized Oxygen(Gas)

The following equations summarize the basis chemical reactions representing, when taken in aggregate, the photolytic energy transduction. This process results in the conversion of water into oxygen, O₂, H+ ions, and electric power/electrons.

### Photolysis Yielding Charge Separation and Formation of Active Oxygen

2hν+TiO₂(anatase)→AO+2e−scb (12)

Where AO designates a solid-state active form of oxygen, for example the peroxo species “{TiO₂(O₂=)2+}(bulk)”, and where “bulk” represents the bulk solid phase of the photocatalyst film. The quotations indicate a surrogate formula for the transient photo-activated catalyst site within the TiO₂ film where the photon was absorbed (i.e. the “hole” or h+) or any locations within the solid to where the “hole” has migrated via electron exchange other than the surface, i.e., exciton migration. The “scb” indicates that the electron produced upon photon absorption is energetically transferred into the semiconductor band of the titania crystals (or other metal oxide being tested such as zincate or tungstate, without and with dopants and/or dye sensitizers). The quantum yield of the process strongly depends upon removing the e-(scb) so that it cannot reconvert the AO (or exciton) back into the simple oxide ion, results in no net reaction. As shown below, the AO/exciton has a very short life once it migrates, via conventional exciton site-to-site exchanges, to the surface of the photocatalyst (i.e., where species such as {TiO₂—OH₂}(surf) exist) where the titania is in contact with moisture-saturated gas from the fuel cell or flowing fuel cell electrolyte. This migration step also naturally reforms the photon absorption bulk titania film site ({TiO₂}(bulk)) preparing it for absorption of another photon as follows,
Active Oxygen migration to the film Surface and Hydration to Adsorbed Peroxy Species

{TiO₂(O₂=)2+}(bulk)+2{TiO₂—OH2}(surf)→2{TiO2-OOH}(surf)+2H+(aq)+{TiO2}(bulk) (13)

The water present on the oxygen-generating surface is supplied from the bulk aqueous fuel cell electrolyte phase, nominally ˜55 molar. Therefore, water availability is not expected to represent a significant diffusion boundary layer until very high illuminating flux values. Such limits can be determined in conjunction with the specific power density capability of the PDEC module. Theoretically, water diffusion rate constraints would be expected only at very high lamp intensities and the highest oxygen flux values, a limitation not expected for the proposed technology. Once at the surface, the oxygen can be generated spontaneously by peroxo disproportionation as follows:
disproportionation

2{TiO2-OOH}(surf)→2{TiO2-OH}(surf)+O2 (14)

The hydrated surface titania species is regenerated at the same time oxygen forms due to the ready availability of water, at which point it is ready to undergo the next O2 generation cycle. The next step is optional and involves releasing the oxygen as gas or leaving it in oxygen form (oxygenated fuel cell electrolyte). Notice that this ability for direct formation of O2 appears to be a significant asset to the cell process (WBS 3.4) since the slow gas→oxygen solution mass transport step could be avoided by using PDEC to oxygenate the aqueous electrolyte servicing the fuel cell unit. This enhancement could be further magnified by including an oxygen carrier in the electrolyte that is utilized by the fuel cell. Whole blood is an analogy where the hemoglobin of blood increases the oxygen carrying capacity to (concentration) of the aqueous electrolyte (blood in this example) by 30 times over that of water. Alternatively, the oxygen produced could be collected as compressed oxygen gas in an onboard storage vessel as described below.

Pressurized oxygen is achieved by allowing the oxygen concentration to rise beyond oxygen solubility in the bulk electrolyte or aqueous thin oxygen film of the photo-anode side of the PDEC cell where it accumulates to a pressure regulated by the exit pressure release valve previously selected to match system requirements by the on-board fuel cell and/or other propulsion system. Hence, oxygen production rate is regulated by the illumination intensity and hardware design capacity, the quantum yield, and the overall rate of Reaction Steps (Reactions 12, 13, 14). Optimization of the processes is desired. Pressurized oxygen then formed by producing oxygen at a rate higher than the solubility of oxygen in the electrolyte, which is achieved by slowing the flow rate of water to the PDEC cell relative to the oxygen production rate of the cell.

This oxygen is then available as the oxidant for the cathodic side of the fuel cell. Notice that the issue of moisture content of the oxygen gas can arise, both as condensate and as percent relative humidity (% RH) of the product gas. Some moisture (humidity) content is expected to be needed by the fuel cell. However, some/complete dehumidification may be provided if the oxygen is to be used for a conventional physical/chemical (PC) backup fuel cell (PCFC, e.g., H₂/O₂ or other fuel cell). We also note that humidity control and condensate handling is already a well-established technology and, therefore, we expect to borrow from current technologies for handling water balance in the fuel cell fuel regeneration circuit.

On the other hand, it is a further improvement to produce oxygen in pressurized form directly from dissolved oxygen. For the envisioned process, the extent of pressurization of oxygen, a “non condensable gas”, will depend upon 1) the design strength of the external casing for the PDEC device and 2) the prevention of back reaction of Reaction 10, i.e., Reaction 15.

Recombination reaction to be prevented by photocatalyst design

2H++½O₂(g)+2e−scb→H₂O (15)

The first condition requires a conventional pressure vessel design and is not expected to be a problem to bring into the program. The second requirement, however, is fundamental to the design of the photocatalyst and, as given below, can be addressed by incremental improvements in the photocatalyst fabrication techniques accomplished throughout the program as a part of developing increases in quantum yield, in total oxygen and fuel cell fuel regeneration production capacity, and in achieving broader use of the solar spectrum.

### Chemistry Basis for the Photolytic Generation of H+ Ions, Electrons, and Electro-Chemical Reduction Suitable for Fuel Cell Fuel Regeneration

Other pertinent information is provided in this section relating to the generation of the hydrogen ions and electrons to be used for the fuel cell fuel regeneration and the optional membrane for separating the anolyte and photo-catholyte compartments.

The hydrogen ions from Reaction 13 are valuable and offer a number of options for the fuel cell fuel regeneration technology. For the PDEC technology, these ions transfer through the aqueous phase very rapidly, much faster than diffusion, by the well known “hopping” mechanism in which protons transfer from water molecule to water molecule, rather than an individual H+ ion having to migrate the distance. These H+ ions traverse a proton exchange membrane (PEM), preferably Nafion®, a technology already well proven and optimized, and then participate directly or indirectly in the cathodic reaction to regenerate the fuel cell fuel along with the electrons conducted to the cathode that were generated in Reaction 12. To minimize side reactions, the illumination can be pulsed instead of being continuous. The delay caused by illumination pulsation allows the e−scb to be conducted away in one direction and the dissolved oxygen to diffuse away in another. In addition, illumination pulsation prevents the local populations of oxygen(aq) and e−scb from becoming so high that reaction between them becomes fast. The pulse rates involved are extremely short, for example in the μsec-msec range, so that there is little effect on oxygen(aq) production rates, (due to the increase achieved by minimum side Reaction 15. Enhanced yields are also possible for photolytically established charge separation when a bias voltage is present across the coating and geometric construction is taken into account. A small bias voltage may also be used to further reduce the amount of e−scb present at the oxygen generating surface and thereby produce more dissolved oxygen by avoiding side Reaction 15.

Importantly, the chemical substrate for oxygen production requires only a small amount of water derived from the fuel cell electrolyte and/or condensate and is set by the required mass flow of oxygen demand. The formation of oxygen within the TiO2 ceramic nanoporosity prevents direct contact of the fuel cell electrolyte biomaterials, thereby enabling proteinaceous and/or microbial content of the electrolyte within the oxygen formation region. It is also likely that the design can inhibit such biomaterials from ever exiting the fuel cell module in the first place. Note that the illuminated region is only in the solid state and does not contact the aqueous phase. The high gloss surface smoothness of the oxygen-generating surface was selected to prevent fouling solid film deposition on the oxygen generation surface.

### Fabrication of Titanium Dioxide Thin Films:

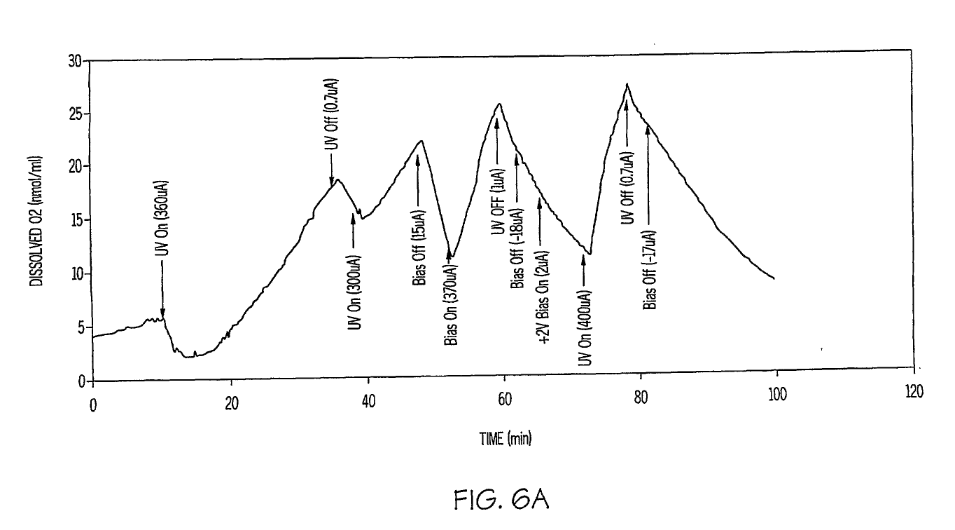

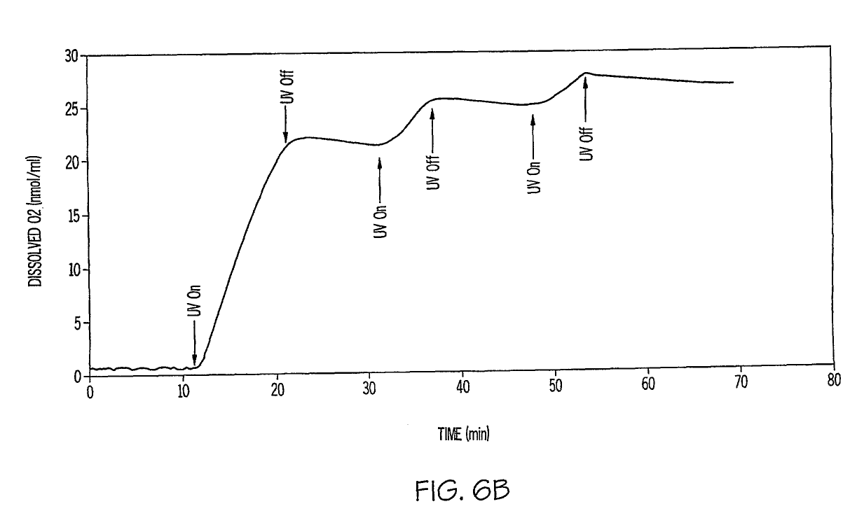

The photoactive construct consists of a solid-state layered structure starting with transparent glass or quartz substrate onto which a conducting film and then a photocatalyst film has been deposited. A similar configuration of batch and flow-through electrochemical cell constituents and device was employed. Thin film photocatalyst fabrication methodology has steadily improved with each generation and has been identified as a key parameter for determining quantum efficiency, largely through preventing electron/hole recombination (FIGS. 6A vs. 6B).

Referring now to FIGS. 6A and 6B. This figure is an illustration of to PDEC Photocatalyst Performance in Hasenbach Photosynthesis Laboratory Test Cells. Impact of catalyst fabrication technique is illustrated where electron/oxygen recombination is observed during dark cycle of the testing for TiO2-filled sol-gel (Figure A), but is insignificant for vacuum-deposited TiO2 (Figure B). Hence the energy transduction efficiency is far greater when highly uniform semiconductor films are used to prepare the PDEC photocatalyst.

Note that for both film preparation tests, and in all cases tested to date, oxygen production and electrical current was not observed in the dark reference tests or when a bias voltage was applied and the catalyst was not illuminated. One volt of bias was applied to polarize the TiO2 film to drive electron migration to the current collector. Such externally applied bias is typically not used in a fully engineered photocatalyst film due to a combination of internal applied bias from a P/N junction, and/or readily reacting (from a thermodynamic chemistry and reaction kinetics perspective). Note that hundreds of microamps of electrical current is observed from about 1 cm3 area of the catalyst film when illuminated. The total current flow also depends on having a facile cathodic reaction provided.

Many photocatalyst films were prepared using both sol-gel and vacuum approaches for both batch and flow cells. For example, glass substrates were 25 mm×9 mm plates with 98% transmissive at the desired wavelength. Thin (<100 nm) metallic (Ti) or semiconductor (indium tin oxide, ITO) conductive film(s) or grids were laid down on a glass surface using conventional vacuum sputter coating procedures. The photoactive layer consisted of a film of titanium dioxide (TiO2), either deposited by sputter coating or formed by sol-gel processing on top of the conducting film.

The sol-gel method for preparing the photocatalyst consisted of the following procedures: The anatase TiO2 powder was HF acid treated prior to deposition, to enhance adhesion, by mixing 1 g of anatase TiO2 in 80 mL of a 1N HCl and 0.1% HF solution for 1 minute. The resulting slurry was divided equally into two centrifuge tubes and centrifuged until sedimentation was achieved. The acid was decanted and replaced with water and the particles to resuspended. The samples were centrifuged and the liquid decanted. This water rinse was then repeated. After the second water rinse and decanting, 40 mL of isopropanol (iPrOH) was added and the particles again re-suspended. Additional film coatings were performed using manganese(IV) oxide, MnO2 (particle size <5 um, Aldrich Chemical Co, Milwaukee, Wis.) as an optional surface component in the anatase sol-gel formulation to enhance peroxide disproportionation rates.

Sol-gel oxide films were generated using spin coating techniques. In this procedure, glass slides containing the conducting layer were placed on a vacuum chuck and rotated at 1000 rpm. For the TiO2 coating, 0.5 g of the acid treated material was added to 40 mL iPrOH and mixed for 30 minutes. Then 0.050 mL H2O and 0.100 mL titanium (IV) tetra (isopropoxide) (TTIP), a sol-gel particle cross-linking reagent, was added to this solution. After mixing for 30 minutes, the solution was added drop-wise to the rotating substrate for a total volume of ˜12 mL. In the case of the constructs containing MnO2, following the addition of 9 mL of TiO2 slurry, 0.20 g MnO2 was added to the remaining slurry. Exactly four mL of the resulting solution was then added drop-wise to the substrate at spin coating conditions. Certain oxidation enhancing modifications of this technique were also examined where RuO2/Pt doped TiO2 (0.125 g) was added to 10 mL iPrOH and added in place of the TiO2 slurry. As sol gel binder for the anatase particles, after 15 minutes of mixing the above anatase slurry, 50 uL water and 25 uL TTIP were added and allowed to mix for an additional 15 minutes during which the sol-gel reactions occur.

This solution was then added drop-wise to the substrate with spinning for a total volume of 9 mL. The sol-gel coated samples were all allowed to air dry at room temperature overnight then placed in a preheated tube furnace and heated at test temperature for 45 min under a IL/min flow of nitrogen.

### Lamp Source

The UVA light from an EFOS Lite unit was directed to the reaction to chamber through a liquid light pipe after being filtered to produce light of 365 nm. The light power at this wavelength was 88.1 mW/cm2 determined at the exit point of the light pipe with a Tamarack Model 157™ hand-held traceable calibration photometer. Heating of the photocatalyst during illumination was minimized because the TiO2 film efficiently absorbed light at 365 nm resulting in little wasted light.

Batch production of oxygen with Concomitant Production of High Electrical Current Density:

Photocatalyst films were prepared and assessed in a prescreening batch testing apparatus. Testing of parameters associated with photolytic production of oxygen from water was performed in the liquid phase cell using a slurry or deposited film of the TiO2 material being tested immersed in a solution of ferric ion at pH 1.9 as an electron absorber. The use of ferric ions allows the tests to be run within the setting of the electrically isolated cell, in which the ferric ions are maintained in solution by the low pH. The ferric ions (Fe3+aq) are converted to ferrous ions (Fe2+aq) during photolysis by chemical reduction by the photolytically mobilized electrons (escb−) from the TiO2 photo catalyst reaction (Reaction 15) followed by Fe3+aq+escb−→Fe2+aq). As Fe2+aq ion is slow to oxidize in acidic media, the co-produced oxygen production rate can be measured directly with a Clark Cell and as the rate of ferrous ion formed. The O2 is produced by the chemical reactions given previously. This ferric/ferrous conversion reaction is useful to assay the quantum yield of O2 production without interference from the recombination side reaction, which then also becomes a measurement of the degree of side reaction to assess photocatalyst designs meant to prevent this side reaction.

The escb− is consumed via ferrous ion formation and is replaced within the TiO2 from adjacent water molecules with minimal diffusional constraints as the water concentration is exceedingly large (55M) adjacent to the photocatalyst surface. This oxidation to O2 occurs despite the high thermodynamic stability of liquid water, due to the high energy level of UV/VIS photons, 365 nm photons in much of the testing to date. In the absence of ferric ions, there is no net oxygen generation as the photo-generated electrons remain available to reduce oxygen back to water at a rate only a little slower than its formation. Therefore, for photocatalyst preparation for the flow cell, uniform film preparation was important. For those tests in which a facile cathodic reaction was not supplied (e.g. the Fe(III/II) reduction used above, a bias voltage (small current voltage) was applied to direct photo-produced electrons away from the aqueous interface at to the current collector film and cathode. Testing was performed with and without the bias and illumination to insure that O2 generation did not occur from the bias voltage applied.

### Flow-Through Test Cell for Assaying Photolytically Driven O2 Generation

A number of flow-through cell based apparati have been prepared. FIG. 2A illustrates an example of the major components of these cells. For testing purposes, whole blood is an excellent electrolyte to use to monitor O2 production with good accuracy as the O2 produced remains in homogenous solution and the analytical techniques for measurement are well refine and rapid. A flow-through, divided, photolytically driven electrochemical (PDEC) test cell was constructed to contact flowing blood with photolytically generated oxygen. This cell was a modified FM01-LC Electrolyser and ElectroCells operating in a divided cell mode with a Nafion® cation exchange membrane. The anode was optically transparent and photons were supplied by side-on illumination using an EFOS Lite® UVA light source filtered to 365 nm (see above). The uncoated glass or quartz side of the plates was illuminated side-on by filtered UVA light. The catholyte was Locke's-Ringer solution, and the anolyte fresh whole bovine blood containing the anticoagulant, heparin sulfate. The blood was obtained from a local slaughterhouse for use on the day of the experiment, thus eliminating the need for extended preservation. Fluids were maintained at 37° C. using a glass in-line heat exchange jacket and flow was 80 mL/min by a Harvard peristaltic pump. Data collected were pH (glass electrode with calomel reference), electrical current (measured using a Fluka 87 volt-ohm meter, VOM, in μA or mA mode as required based on electrolytes used and cell used), temperature, dissolved oxygen (O2, FIGS. 6A and 6B), and oxyhemoglobin (O2Hb). The lamp intensity was varied with and without bias voltage (see above). Control tests made during each run indicated that both bias voltage and UVA illumination was required for significant oxygen formation rate or electrical current flow to occur.

Another way to increase the amount of dissolved oxygen production in the TiO2(a) system is to provide a means to speed the rate of release of the trapped μ-peroxide as hydrogen peroxide as to active oxygen.

Example of intermediate active oxygen formation using H₂O₂

Ti(IV)-O—O—Ti(IV)+H2O→Ti(IV)-O—Ti(IV)+H₂O₂(aq) (16)

Hydrogen peroxide is an excellent candidate form for the active oxygen species as it readily migrates and is easily catalyzed to disproportionate into dissolved oxygen and water.

Example of spontaneous Oxygen formation from active Oxygen using a catalyst system

### Catalyst

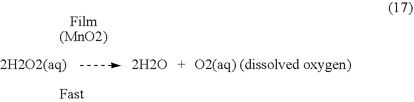

Enhancements to the TiO2 photocatalyst film provided a means for releasing the μ-peroxide rapidly as soluble hydrogen peroxide because hydrogen peroxide can diffuse to the MnO2 adjacent film for dissolved oxygen production or by the Ti(IV)-O—O—Ti(IV) to electronically remove electrons from the MnO2 cluster/particle by directing them to a carrier (as is done in green plant photosynthesis by a reversible quinone/hydroquinone reaction). Inorganic systems, such as ferri/ferrocyanide, or triiodide/iodide ion, cerium(III/IV), redox couples, are also candidates and are well proven and extremely stable redox systems needed for the long-lived compact power system objective. In this case, only an electron flows from the water through the MnO2 to the μ-peroxo linkage through delocalized bonds in a solid state arrangement. This electron replaces the e− lost from the TiO2(a)-OH system as e−scb.

The formation of hydrogen peroxide as the active oxygen is valuable since hydrogen peroxide can be rapidly converted to dissolved oxygen in 100% yield using many different methods: thermally; metal ion catalysis; particulate/surface catalysis; base catalysis; and free radical reaction with reductant initiation. Preferably, metal ion catalysis, such as, MnO2(s), provides an efficient catalyst for hydrogen peroxide disproportionation to water and oxygen, on thin film substrate constructs.

Photo catalyst systems such as zinc oxide, ZnO, release peroxide as the active oxygen more readily than does TiO2. Less acidic metal ions under the Lewis acid/base theory definition cannot sufficiently stabilize the highly alkaline peroxide ion relative to water protonation (pKa1 of hydrogen peroxide is 11.38 (25° C.) to form it within the solid phase, and so hydrogen peroxide, hydrogen peroxide, is readily formed from ZnO:

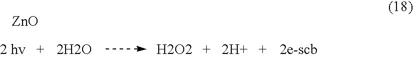

ZnO films and particles can be prepared in a number of ways with varying but controlled composition, morphology and porosity. For example, mirrors of zinc, doped zinc, and zinc alloys and can be sputtered down onto an optically transparent support, followed by oxidation with O2(g). This treatment produces a metal/metal oxide (Zn/ZnO) film. Another highly effective approach to semiconducting ZnO-based films is to utilize a process for optical glass coatings. The optical glass coating technique is based on applying a zinc nitrate/glycine aqueous solution as a dip or spray, followed by drying (110° C. for 15 min), then heating (450-500° C. for 3 min) to initiate a self-oxidation reaction during which the carbon and nitrogen exits as gases leaving an adherent yet porous film bonded to the underlying surface (e.g. glass) and is referred to as the glycine nitrate process. The ZnO film is normally produced doped with alumina by including aluminum nitrate in the aqueous formulation for the initial dip. Many other metal ion blends are also possible with this technique.

Tungstate, WO3, is another photocatalyst to be evaluated. Tungstate only requires visible light to produce dissolved oxygen, and produces dissolved oxygen directly without requiring a second catalyst to form dissolved oxygen. The lower photon energy requirement for WO3 is due to the smaller band gap of 2.5 eV versus at least 3 eV for TiO2(a). As with the TiO2 anatase system, high yields are possible with the WO3 catalyst if the e−scb is removed. The production of oxygen increases very significantly if RuO2 (ruthenium oxide) is placed on the surface of the WO3. This is consistent with the fact that RuO2 is a known good catalyst for oxygen production and so represents a route to improving other approaches.

An advantage may exist if the oxygen producing catalyst film could be a filled plastic. Such materials are often inexpensive, resistant to breakage, and manufactured easily. To facilitate construction of such materials, commercial sources exist for semi-conducting, low light absorbing, inorganic fillers for plastics that are supplied in ready made condition for incorporation into plastics, making the plastics electrically conductive. For example, E.I. DuPont Nemours, Inc. sells electroconductive powders (EPC) under the trade name ZELEC® ECP for such purposes. The conductive substance in ZELEC® ECP is antimony-doped tin oxide (SnO2:Sb). The bulk of these materials, onto which the conductor is coated, are familiar inorganics such as mica flakes, TiO2, and hollow silica shells, or ECP-M, ECP-T and ECP-S respectively. Pure SnO2:Sb-based material is designated ECP-XC and is a much smaller particle than the other materials. About 25-45% by weight of the ECP products are used so that the particles are sufficiently close to each other to provide internal electrical connections throughout the otherwise non-conducting plastic. ECP-S and ECP-M normally perform best for lower concentrations. Thin films of ECP-XC can provide an attractive coating because they are very fine grained and strongly light absorbing.

The TiO2 layer can be formed a variety of ways. The TiO2 layer can be formed by sol gel, drying and baking. A product under the trademark LIQUICOAT® from Merck & Co., Inc., which hydrolyzes Ti(OR)4 type material in water to form TiO2 and 4ROH can be used to form the TiO2 layer under a sol gel/drying/baking process. TiO2 can also be formed from preparing an anatase suspension from dry powder, then dipping, drying, and baking the suspension to form the TiO2 layer. Another way the TiO2 layer can be formed is by e-beam evaporating titanium and subsequently exposing the titanium to oxygen within a deposition chamber. The TiO2 layer can also be formed by adding titanium salt to water and adjusting the pH to ˜2-7 to form a suspension, then dipping the suspension and allowing the suspension to dry.

The catalyst used to convert active oxygen into dissolved oxygen includes metal ions capable of redox cycling, such as Fe(II/III), Cu(I/II), Co(II/III), Mn(II/III/(IV)), Ag(I/II), and others, and could physically be prepared in metal oxide form as films and particles. A particularly good system is the same as that used in PS-II (see above), MnO2. The present reaction produces oxygen directly from water. The MnO2 catalyst is most preferred because it forms dissolved oxygen efficiently, selectively and rapidly, and is not highly dependent upon the active oxygen form of oxygen as the MnO2 cluster, as in PS-II is capable of several readily interconverted oxidation states. No doubt this it the property, along with the availability and insolubility at physiological conditions and rapid ligand exchange rate, that makes Mn ion hydrate ideally suited for the PS-II catalyst.

Another way to facilitate the conversion of active oxygen to oxygen is by doping the surface of the TiO2 anatase with manganese (Mn). Surface doping the TiO2 with Mn provides highly productive active oxygen to oxygen conversion catalyst. Active oxygen disproportionation is spontaneous and rapid when exposed to a Mn-doped anatase surface. Alternatively, active oxygen can also be converted to oxygen by placing MnO2 on the surface of the anatase in conductive form. In this form, electrons are catalytically passed from water to the active oxygen region of the anatase. Such an arrangement more closely mimics photosynthesis oxygen production.

Another way to convert active oxygen to oxygen in the photolytic cell is by using a MnO2 octahedral molecular sieve (MOMS) material as the dissolved oxygen catalyst. The MOMS material has an open gel-like structure and is closely related to zeolites in structure. The MOMS material is easily formed from manganese salts through precipitation and drying.

Active oxygen may also be converted to oxygen in the photolytic cell by a superoxide dismutase (SOD) catalyst. SOD catalyst is a well characterized and efficient enzyme and can provide the required conversion of active oxygen.

### Cation Exchange Membrane

The cation exchange membrane allows for the diffusion of cations in the photolytic cell. Particularly, the cation exchange membrane allows a cation, such as sodium ion (Na+) or hydrogen ion (H+) from the anolyte to diffuse through the membrane and enter the catholyte to participate in cathodic reactions there. The cation exchange membrane is commercially available under the trademark NAFION® and is available from E.I. DuPont Nemours Inc. NAFION® cation exchange membranes are a perfluorosulfonic acid/PTFE copolymer in an acidic form. Although NAFION® cation exchange membranes are currently the preferred membrane.

### Catholyte Formulation Selection

The catholyte composition to be feed to the PDEC cell is important to the compact, long-lived fuel cell. The PDEC catholyte composition can be a wide range and so it is felt that catholyte composition will not be a limitation from the PDEC view point provided sufficient highly selective chemical conversions can be accomplished. Aqueous solution, for example acids, bases, salt solutions, synthetic blood serum, and even whole blood, have been found to be functional. This accommodation is possible due to the use of corrosion and thermally stable PEMs (Nafion is used to manufacture 30% NaOH and chlorine electrolytically), and the cathode material and cell housing can be a wide range of corrosion resistant materials (typically titanium, stainless steel, polymers, ceramics, glasses, cermet and other composites, and/or plastics).

As the catholyte can receive the spent fuel cell fuel from the fuel cell, and perhaps occasionally from a backup redundant fuel cell energy system too, catholyte selection can be performed in close concert with the evolution of the fuel cell. For a fuel cell the expectation is that the catholyte can be conditions compatible with stabilized enzymes and/or immobilized microbiological systems. Hence the expected catholyte can be saline solutions of mid pH values containing high as possible concentrations of the fuel candidates, probably in excess of >10%. The description of the Approach below contains much more detail on the combination of catholyte chemistry involved in evolving PDEC technology for high annualized energy density compact power systems.

Photolytically Driven Electrochemical (PDEC) based Fuel Cell Fuel Regeneration Integration with all Types of Fuel Cell Device Designs Fuel cell fuel regeneration is accomplished using the discovery that mimics certain aspects of green plant photosynthesis and uses robust materials of construction for device durability and long service life. Specifically, light harvesting and energy transport as occurs in chloroplasts and photolytically driven electrochemistry (PDEC) that accomplishes the charge separation of Photosystem II (PS-II). The invention, when integrated with high power systems provides the energy needed for powering vehicles of many types, to including those electrically powered, rocket powered, and the like, thereby producing and regenerating a wide range of conventional and future fuel cell fuels, and providing the continuous regeneration of a large range of fuel candidates.

In PDEC, as in PS-II (PS-II is the oxygen generating portion of the plant photosynthetic system), electrons, oxygen, and hydrogen ions are generated from water molecules using light energy derived from any source and within the wave length window of 120-1000 nm inclusive, and preferably 190-750 nm, and most preferably 340-450 nm. PDEC features the involvement of minimal diffusion barriers associated with oxygen generation, that would otherwise limit performance of conventional electrochemical cell, fuel cell, or gas-fed devices. With the production of three reactants, a much more versatile technology is provided relative to conventional photovoltaics or direct photolytic water splitting. With PDEC, the electrons and hydrogen ions can be combined to form hydrogen molecules and/or instead reacted with an organic compound at the cathodic surface to accomplish chemical reduction, thereby resulting in the regenerated of fuels for conventional and projected fuel cells or caloric foods. The key fundamental requirement and objective for the PDEC device is to produce oxygen and to produce electrochemical reduction potential, ER, that is at least sufficient to accomplish at least a portion of the fuel cell regeneration. ER for fuel cell fuel regeneration, is that potential remaining after a portion of photolytic energy has been consumed for oxygen generation. This limitation sets the lower acceptable photolytic energy to 1000 nm.

Therefore, as an optional second aspect of the PDEC device of the invention is to increase the cathodic cell voltage by one or a combination of two methods. The first is to electrically connect two or more of the PDEC cells in series such that their output voltages add.

The second option to achieve higher cathodic potentials is to incorporate a second photolytic cell using a strategy of using photochemistry akin to Photosystem I (PS-I). This method involves the incorporation of additional energy from light photon to enhance the reduction potential of the electron freed from oxygen production. In this case, charge separation is not involved, as the electric current for the cathodic reaction is already available from the primary PDEC photocatalyst as described above, just synchronized conventional light absorption.

The Table below provides a list of fuel candidates which meets the projected requirements of the conventional fuel cell (H2), projected future fuel cell (e.g. JP8, JP8 surrogate, ethanol, methanol, and so on), and other fuel cells integrated with the PDEC device. In this manner, useful photo-electrical currents and cathodic voltages are generated by the PDEC device for fuel cell fuel regeneration and/or oxygen supply to use to power a wide range of fuel cell types, a rocket, or other power generating system. It is recognized that, due to the limited energy instantaneously available per unit area from solar illumination, that the PDEC is not expected to provide continuous high density power, and this high power task is provided by the integrated fuel cell or rocket, and is normally utilized non-continuously. For example, for small robotic craft or manned space craft, during maneuvers or operation of on board electronic devices and systems. The integrated system then also can perform through periods of darkness, shadows, or dim light, where recharging is accomplished during periods where illumination is available either using solar power or lamp illumination. Hence the role of the PDEC unit of the integrated system is to provide fuel and oxygen alone or in combination of other available supplies of these materials from on board stores or otherwise, especially when time and energy source and demand allows. The fuel and/or oxygen materials can be used directly, and/or, most preferably, stored for more timely use by the high energy production unit or as a food. The regenerated fuel for an onboard fuel cell, as fuel cells can use concentrated energy sources, such a gas or, preferably, liquid, hydrocarbons, alcohols, aldehydes, ketones, carbohydrates, CO, and/or H2, including mixtures of these fuels, to generate the high power level required by the vehicle or the food consumed by persons. PDEC may also provide onboard power, normally at a lower density, for example when such fuel stores are fully replenished and/or solar energy is still available and the high power of the fuel cell(s), rocket(s), on board batteries are fully charged, and when solar energy, nuclear energy, energy of motion, and the like is available and spent materials such as spent fuel cell fuel, H2O, CO2, and the like are still available. An example of such a situation is on Mars, where CO2 and water are available in large supply from the Martian environment, or on Mars or the moon or space craft green houses.

Another aspect of the invention provides for solar energy transduction technology to provide long-lived high power and photolytic (not electrical) chemical conversions, and optionally, for the generation of electrical power from solar energy for storage and use with a power supply, and for electrochemical regeneration of fuels for conventional and future fuel cells, including fuel cells.

In the fuel regeneration PDEC compartment, the hydrogen ions and electrons can be used to regenerate the spent liquid or gaseous fuels selected for the fuel cells (conventional and projected). The regenerated fuels can be stored in a small, appropriately sized, holding compartment, or “surge tank”. Spent fuels can be collected from fuel cell operation, and collected in an onboard, appropriately sized holding compartment (FIG. 3). Both low volatility compounds, e.g. sugars, higher aliphatic alcohols, and polyols, and more volatile fuels, e.g. ethanol, methanol, isopropanols and other lower aliphatic alcohols and carboxylic acids, e.g. acetic or formic acids, regeneration, can be produced. Typically electro-chemically pressurized (i.e. not mechanically pressurized) hydrogen (H2) can be used for the conventional fuel cell case. In addition, the photolytically formed humid oxygen (or optionally H2O2) is typically pure and available for immediate reuse in the conventional, future, and photochemically pressurized fuel cells as the internal humidity is important for PEM membrane performance. The regenerated fuel cell fuel can be stored until power is needed thereby providing a long-lived, high power energy source. In this manner the efficient use of solar energy can be used to drive long-term power production to capabilities.

Note that some aspects of PDEC are typically more versatile and photo-efficient technology than conventional photovoltaics (PV) or “water splitting” technology as the products of PDEC (active oxygen, electrical current and hydrogen ions) are produced separately and kept in separate compartments of the PDEC cell, thereby providing more process options, such as liquid or gaseous fuel regeneration and providing oxygen for the fuel cell, while eliminating the need for complex separations. These features reduce maintenance requirements and lengthen in-service life.

The photolysis side of the PDEC technology has already been proven effective, providing chemical changes at physiological electrolyte conditions in the presence of protein-containing, biocompatible, electrolytes, including synthetic electrolytes, including blood serum simulant, and including whole blood (human and bovine). Hence the approach to identify fuel cell fuels, involves performing cathodic photolytic and electrochemical testing for fuel candidates from the list of compounds on the Table.

A 3D flow-through PDEC cell structure, a “construct”, can be designed and assembled using typically microfabrication, (μFAB) Integrated Circuit (IC) photoresist, vapor deposition, etching and other related thin film fabrication (FAB) technologies. The 3D structural design can be selected using computational fluid dynamics (CFD) modeling of enzyme-compatible electrolyte fluid-flow across the active surface and within a confined space to determine the geometry and minimize size. Microfabrication provides large internal surface areas for the PDEC reaction surface in solid state and durable form. The specific geometry and materials of construction of the PDEC module can be determined by needs, fuel cell enzymatically driven biocompatibility, and fuel regeneration rates. These structures may be stacked together into a space-efficient arrangement that can result in a compact device that is capable of using photolytic energy to produce oxygen, electrical current, and H+ ions, at a high rate for rapid and efficient power supply charging, and fuel cell fuel regeneration.

### Fuel Regeneration

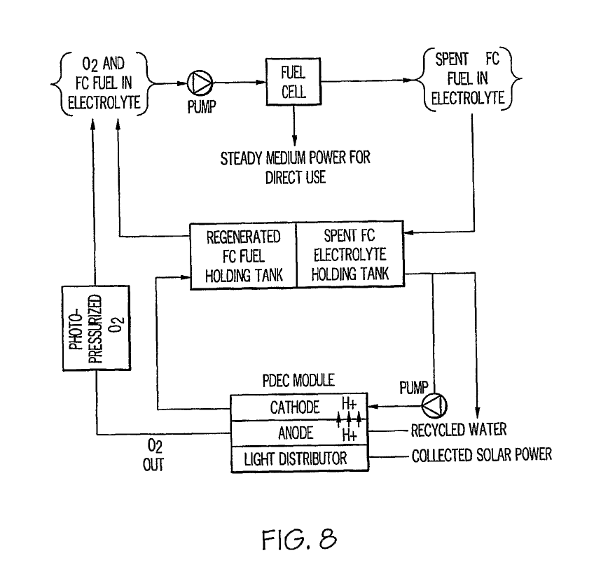

The primary design requirements for the fuel cell FR subsystem is focused on the cathode and catholyte. When the spent fuel is taken from the fuel cell spent fuel surge vessel (FIG. 8). It will need to undergo highly efficient chemical reduction at the especially selected PDEC cathode using electrons and hydrogen ions generated at the photocatalyst anode. The high yield is a product of cell operating conditions and the cathode material, normally a metal or metal alloy. The regenerated fuel is then sent to a fuel tank until needed.

Alternatively, the spent fuel is continuously removed in a non-exhaustible manner provided by the PDEC-powered fuel cell fuel regeneration module with power to the unit maintained. If power is turned off or lost temporarily, the system should self-reestablish normal function on power recovery.

Broadly, FIG. 8 illustrates the interaction of the PDEC unit with the other systems. FIG. 8 illustrates the general process schematic for the fuel cell fuel Regeneration System using PDEC technology. The spent fuel, an electrolyte containing a high (5-50%) concentration of spent fuel and residual excess fuel flows from the fuel cell and is collected in a surge reservoir. This liquid is then pumped, using a small low pressure pump, into the gas tight PDEC cell where photolytically-powered reduction takes place to regenerate the fuel. The regenerated fuel, still under flow from the feed pump, flows into the fuel reservoir where it is pumped to the fuel cell when power is needed. The oxygen cogenerated at the PDEC anode is also collected in a surge tank already under the natural pressure of the PDEC cell thereby avoiding the need for a mechanical pressurization pump and therefore its weight, bulkiness, and its high power demand. Instead, the pressurization of the oxygen is also driven by the photolytic power by maintaining the system closed. Pressurized oxygen increases the power output of the fuel cell.

The sensors, controls, and supporting hardware are selected to support the final subsystem design. Standard laboratory pumps can be used in the planned work to reduce costs since the specific pump to be used is not a to critical innovation required by the system. Likewise, for fuel cell fuel regeneration testing the anodic photochemistry will be simulated using a DC power supply to supply the voltage and current density demanded by the fuel cell fuel regeneration cathode electrochemistry. This approach enables quantitative measurements of voltage, current density, production rates, and product determinations at the cathode without the complications of a non-optimized photocatalyst.

Elements for consideration for the cathode include physical structure and composition. The cathode can be made from soft metals like zinc, cadmium, lead, copper, steel, platinum or titanium, plated or alloyed. To form reduced hydrocarbon compounds, for example, alcohols or polymers are typical of desirable reduced carbon products. Many product materials are available for consideration for either of these electro-chemical treatment routes.

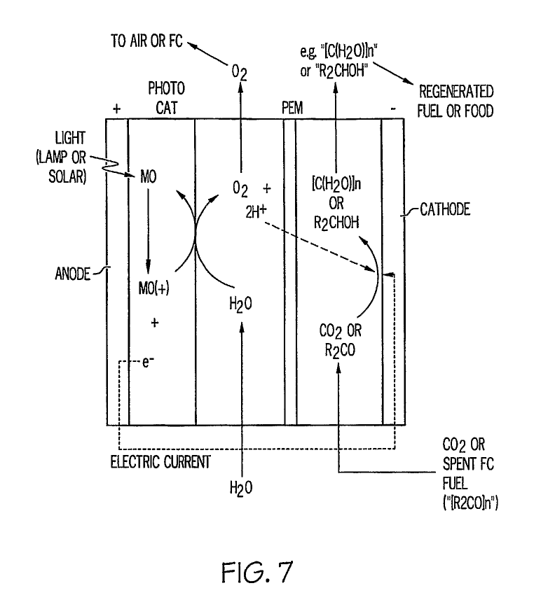

FIG. 7 is a schematic drawing of PDEC cell internal flow for fuel cell fuel regeneration and oxygen Production. Major components of the design include a fuel electrolyte pickup pump and line, a photocatalytic anode where oxygen is generated simultaneously pressurized and returned to the oxygen storage tank, a cathode for cathodic chemical reduction, reducing the spent fuel back to energized useful form. A cation exchange membrane separates the electrodes and selectively allows H+ ions from the anolyte, generated at the anode, to migrate to the cathode participating in the fuel reduction. Pressurized oxygen is generated at the anode. Water balance would be provided (not shown) and would depend upon the requirements of the fuel cell as well as the PDEC cell. In general water balance is not expected to be a major issue as it is desirable to retain water in the system for the microbial/enzyme(s) fuel cell catalyst(s) present, and not purge it, as is the case with conventional H2 fuel cells. PDEC also uses an aqueous electrolyte. Hence the need for critical and complex water balance operation is eliminated, and replaced by a system that may or may not require minor adjustments.

The PDEC photocatalyst provides the electrochemical power source for fuel cell fuel Regeneration and oxygen production and pressurization. Absorption of light energy by the photocatalysts promotes electrons to the conductance band of the catalyst causing an electrical current to flow and allows the “holes” left behind to oxidize water to oxygen and H+. Liberated electrons are then carried via an external conductor to the cathode reducing spent (oxidized) FCR to regenerate it. This task makes critical improvements to the cathode and photocatalyst. Efficient power conversion and high fuel cell fuel regeneration yield are critical design parameters. Efficiency of the charge separation step within the catalyst film determines the critical design parameters controlling the ultimate size, weight, and power density of the finished PDEC Subsystem. Specifically, the need is to design into the photocatalyst, using vacuum sputter coating, chemical vapor deposition and epitaxial deposition, and related fabrication techniques, features and elements that optimize photon absorption by desired electronic transitions, adhesion, charge separation and energy transformation.

Detailed Description of fuel cell fuel regeneration Approach and Integration with the Fuel Cell and Light Harvesting Unit Operations

Although the literature around the photochemistry of titania has centered around its use as a particulate and for the destruction of recalcitrant organic pollutants, it has been discovered how to direct this energy source in a manner to generate oxygen and H+ ions from water while producing electrical current (see FIG. 7). The easily transported H+ ions and electrons are utilized in a cathodic reaction, separate from the location of anodic oxygen generation reaction, to accomplish fuel cell fuel regeneration. An explanation of this photochemical fuel cell fuel regeneration approach is provided below.

STEP 1: The following equations comprise the basis for the photolytic conversion of water to oxygen with simultaneous generation of electrons for cathodic reactions and hydrogen ions (Reaction 10). This reaction is the primary energy transduction step where the photolytic energy is efficiently captured in a form readily used to carry out a range of useful oxidation/reduction electrochemical reactions (“redox” reactions). Titania is used here to illustrate the technology in its simplest form. The ultimate refined metal oxide photocatalyst film is typically a blend of oxides as solid solutions or stacked films with or without dye sensitizers, for example including tungstates and zincates. Such mixtures allow the use of a much broader use of the solar spectrum while keeping the fundamental oxygen generation photochemistry the same (shown below). Therefore it is expected that the effective photons can have a wavelength of 750 nm or shorter (energy 13,200 cm-1 or higher). In air the shortest wavelengths will be limited to about 190 nm (52,600 cm-1) due to absorption by oxygen. Hence, for terrestrial applications, essentially all of the nonthermal portion of the solar spectrum that is transparent to the atmosphere can be utilized for fuel cell fuel regeneration, including most the visible spectrum, and the entire UV spectrum outside of vacuum UV (UVA, UVB and UVC components). As the metal oxide photon absorbents can be selected to have high efficiency for accomplishing energy capture the energy efficiency ultimately will be set by the efficiency of the light harvesting network.
STEP 2: As discussed earlier, active oxygen has a very short life once it migrates to the surface of the photocatalyst ({TiO2-OH2}surf) that is in contact with the water supplied either in vapor or in liquid form. This migration step reforms the photon absorption bulk titania film site ({TiO2}bulk) resetting it for absorption of the next photon.

Note that the H2O present on the oxygen generating surface is supplied from a bulk source. In the case of a fuel cell this would normally be the aqueous phase electrolyte used by the enzymatic/microbial fuel cell medium, which is nominally 55 molar and so does not represent a significant diffusion boundary layer.

STEP 3: Once the “hole” reaches the surface via Reaction 13, the oxygen is generated by spontaneous disproportionation and without involving a gaseous phase (Reaction 14).

The oxygen then diffuses out of the nanoporous surface at a flux proportional to the lamp intensity provided, the quantum yield, and the overall rate of reaction steps 1, 2 and 3. The oxygen migrates through the thin aqueous film (for example using a wicking film contractor element, for example such as are used industrially to humidify air or provide gas/surface absorption) where it rapidly forms pressurized gaseous oxygen.

Light Harvesting targets collecting light from across the solar power spectrum of electromagnetic radiation and provide this light to the PDEC cell for photo-transduction using optical transportation techniques. Where wavelengths need to be adjusted, conversions will be made. The hydrogen ions from Reaction 13 spontaneously transfer through the aqueous film phase via the well known “hopping” mechanism and then diffuse through the solid state proton exchange membrane (PEM) (FIG. 7). Note that the PEM is a technology already available from conventional physical-chemical (PC) fuel cell technology.

Importantly, the chemical substrate for oxygen formation is water derived from the fuel cell electrolyte and/or system condensate. The formation of oxygen within the TiO2 ceramic nanoporosity prevents direct contact of fuel cell electrolyte to the oxygen formation region. The illumination region is typically only solid state. The high gloss surface smoothness of the oxygen generating surface was selected to discourage biofouling.

### STEP 4: Fuel Cell Fuel Regeneration

The primary goal of the PDEC system will be to regenerate the fuel cell fuel produced by the fuel cell and for any on board backup fuel cell or combustion system (FIGS. 3 and 8). This capability is critical to achieving both the very long time (years) between system refueling and the much higher power density relative to conventional systems based on a kwh/kg/year basis. This anticipated major advantage will be mostly due to not requiring huge fuel tanks of conventional technology that even still require frequent refilling. In a development the PDEC fuel cell, a fuel regenerator will make it possible to provide just one (or two) relatively small onboard fuel tank and also not have to refill it using ground operations for years at a time. Using data mining of the electro-organic chemistry literature, industrial practice and academic publications, an initial list of numerous fuel cell fuel candidates and candidate chemistries were identified. Note that these compounds may contain the final fuel candidate, or, more likely, contain the chemical class of the most desired fuel. The most desired fuel will be a product of refinement testing in which fuel recycle yields and selectivity will be increased systematically using a “constant improvement” statistically validated program.

Encouragement that such a durable recycle fuel is possible is gleaned from other historical chemical products meant for multi-year demanding applications, such has hydraulic fluids, lubricating oils, certain long-lived surface finishing bath chemistries, and especially heat transfer fluids. All of these products last for years in field use while being subjected continuously or intermittently to demanding heat, temperature, pressure and oxidizing conditions in demanding applications such as aerospace, heavy construction, chemical manufacturing, power generation, high current densities, and many others.

Hence the fuel selection protocol will be to evaluate fuel cell fuel candidates with respect to electrochemical regeneration yield and selectivity. The critical selection parameters, other than fuel cell performance, will be by-product production, which must be kept to <<1% per recycle. The general approach to refinement will be to determine both reaction yield and regeneration selectivity, but also determine the byproducts that are formed during fuel cell use and fuel regeneration processing. Once a particular significant byproduct is identified, then the mechanism for its formation is deduced and blocked. The testing is then repeated to identify the next to byproduct of concern, which again is designed out of formation.

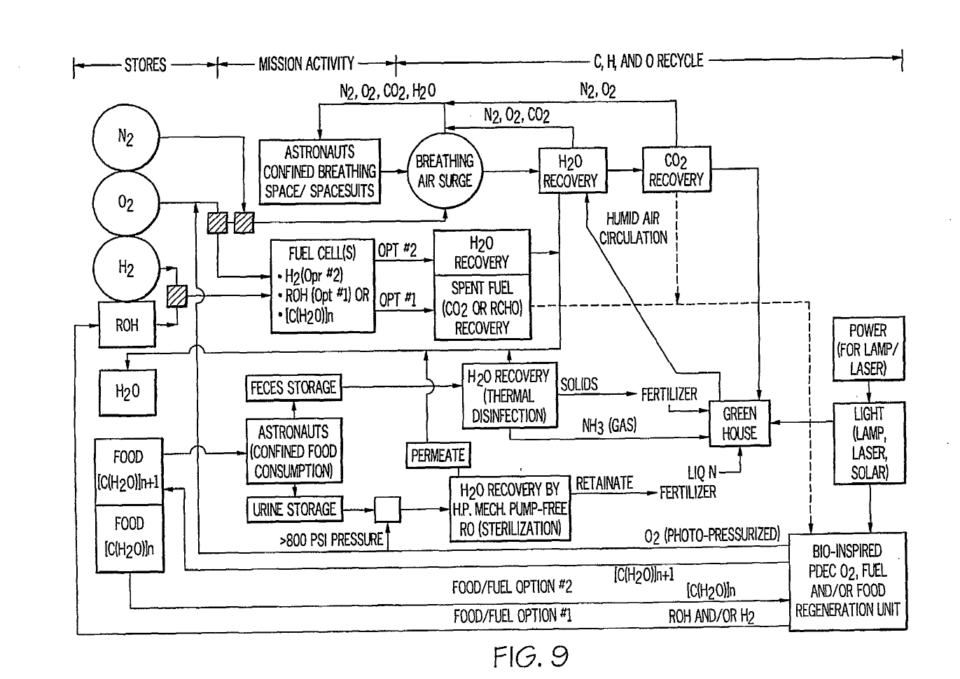

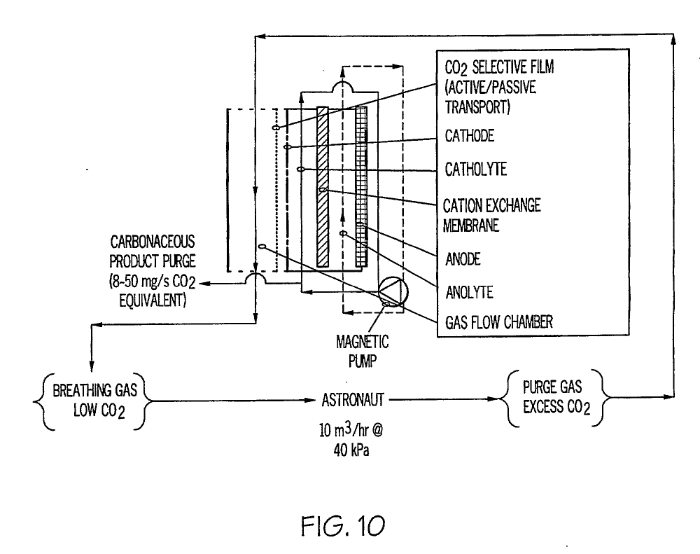

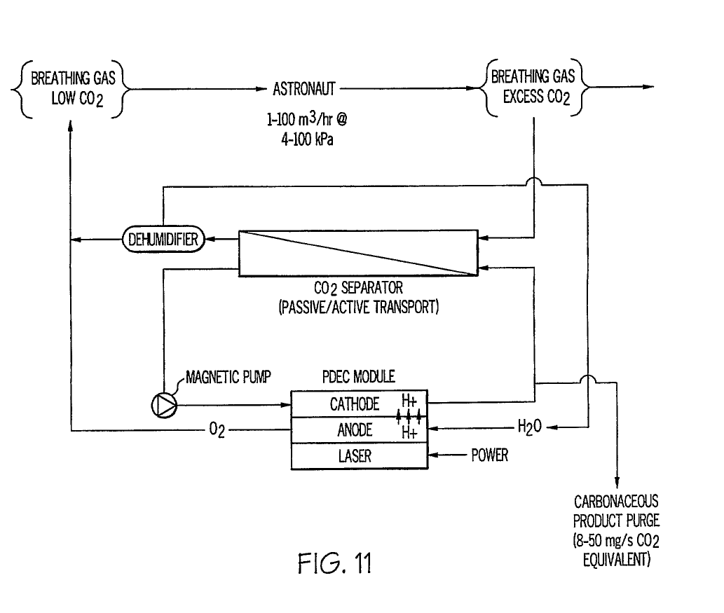

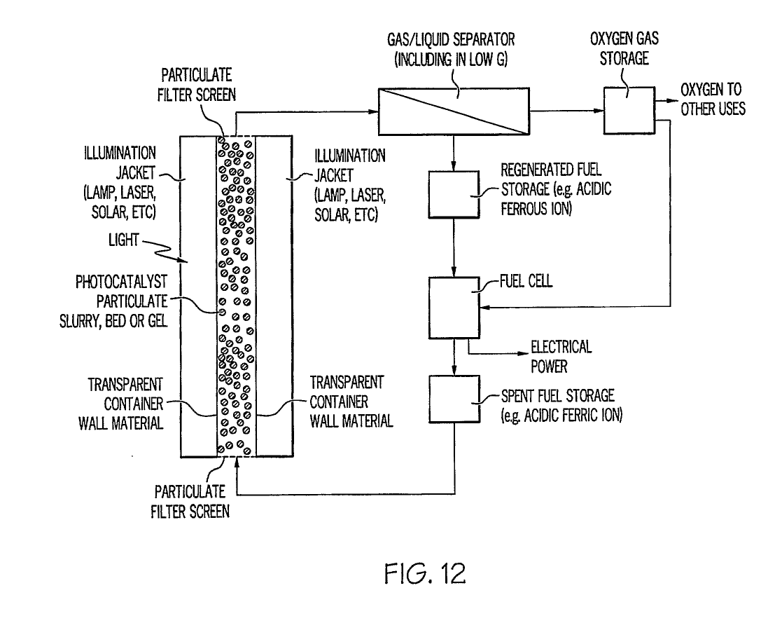

FIG. 9 summarizes the specific method for developing the PDEC fuel cell fuel regeneration processing unit portion of the overall high annualized power density, compact power system. The PDEC subsystem will provide highly selective fuel cell fuel regeneration, and, optionally, photo-pressurized oxygen and/or CO2. These products, fuel and oxidant, will be delivered to storage vessels supplying the fuel cell unit(s), breathing atmosphere, or rocket motors.

Annualized power density means that the power generated from the device including mass of the makeup fuel consumed (not regenerated fuel) plus the mass of fuel cell over a period of one year. By recycling the fuel with solar energy the net fuel mass added is substantially smaller than without recycle.

The low voltage/high amperage electrical power produced by PDEC, used to regenerate the fuel, may also have other utility if fuel cell fuel regeneration needs are met, for example adding to peak power demand, to extend system life, and/or to provide backup battery charging. Photocatalyst and cathode surface catalyst detailed designs largely control the maximum power density of the PDEC cell.

While conventional oxygenation technologies function by delivering pressurized oxygen from heavy gas cylinders to the fuel cell or other energy system for once through usage, resulting in waste gases, normally CO2 and/or H2O for disposal. The invention provided herein uses photolytic energy to generate oxygen from the water recycled from the waste gases and liquids, thus eliminating the need for gas delivery from distant localities and on site storage. We have determined that it is feasible to generate oxygen from water based on the interaction of UV light with a highly absorbent metal oxide-based film, preferably doped for high photon efficiency, and layered with other co-deposited films allowing simultaneous performance as a flow-through oxygen generating cell and electrochemical cell. In the examples below, photolytic energy is used to generate oxygen from aqueous solutions thus resulting in oxygen production with TiO2 surface illumination. In some of these experiments, mixed venous bovine blood, and excellent sorbent for oxygen for quantitative analytical measurements, was flowed in a re-circulating loop over a nanocrystalline TiO2 thin film illuminated on the side opposite the blood (to eliminate the potential for exposure of blood to light). Following light exposure of the TiO2 film, the fraction of oxy-hemoglobin in the blood rapidly increased to near saturation, and remained stable throughout the trial period. The fraction of dissolved oxygen contained in the serum phase of the blood increased in parallel with oxyhemoglobin, indicating that near complete oxygenation of the hemoglobin was achieved. We conclude that it is feasible to photolytically generate oxygen, in this example from the blood's own water content, thereby removing the need to force oxygen gas dissolution from supplied heavy oxygen tanks.

Conventional oxygen delivery technologies are based on the delivery of expendable oxygen from replenished oxygen tanks. Other systems supply point-of-use oxygen directly from air and depend on pressure swing membrane diffusivity and differential gas pressure to drive oxygen/N2 separation. The principal weakness of these systems is that they require major diffusion boundary layers linked in series, which results in slowed mass transport and therefore the need for a large surface area and gas compressors to achieve sufficient flux of gases and hence large, not portable and heavy systems. In addition, these systems require a continuous source of exogenous pressurized oxygen via heavy metal tanks. The present invention circumvents these limitations by recycling the H2O and CO2 products, using photolytic or other energy sources, rather than replacing the elements of C, H and O. Rather than delivering oxygen to the remote or confined facility, or moving carbon dioxide against a back pressure of CO2 or and in-flow of oxygen, we use photolytic energy to indirectly generate oxygen to and fixed carbon (symbolized herein as carbohydrate or C(H2O) directly from recycled H2O and/or CO2.

### Approach and Methods

Chemical Basis of Photolytic Reactions for Oxygen Formation from H2O and Carbon Dioxide
Reduction from Spent Fuel Cell Fuel to Accomplish Fuel Cell Fuel Regeneration

The following equations comprise the basis for the photolytic conversion of water to dissolved oxygen and the reduction of spent fuel cell carbonaceous fuels and fixation of carbon dioxide 18. In this example, the initial chemical substrate is the water, which, upon photoactivation to active oxygen within a metal oxide film, preferably of titania alone or doped with certain metal ion sensitizers, carbon, graphite, and/or organic or organometallic dyes, is substantially converted to oxygen, electrons and H+ ions. Such photochemical catalyst(s) films are in intimate contact with a metallic or semiconductor element, preferably a film or a screen, and as a transparent film in the cases where illumination is to be through the electrical conducting layer, and otherwise can be opaque or poorly transmitting. The electrolyte can be any salt solution, including blends of salts and/or pH buffers, that do not appreciably absorb the illuminating light and are not photo-degraded sufficiently to retard the formation of excitons in the photocatalyst film. Opaque electrolytes, including whole blood, can be used provided the photocatalyst is not illuminated through the electrolyte and is instead illuminated through the conductor film. An example of the latter case is where the conductor film is deposited upon a glass, quartz, or clear and colorless plastic material, so that the light can enter the photocatalyst via the this clear substrate.

### EXAMPLE 2

### Key Photolytically Driven Electro-Chemical Reactions for Oxygen Production And CO2 Removal Gas Streams from Fuel Cell Exhaust and Breathing Air By Forming Bicarbonate Solutions

This example illustrates how CO2 is purged from fuel cell exhaust gases or from accumulations in confined breathing atmospheres while producing oxygen gas from the moisture present in such fluids, liquid or vapor/gas.

### Step 1. Photolysis

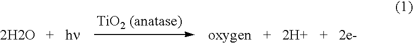

### Step 2. Transport of Electrons to Cathode

2e−→electrical conductor/semi-conductor film→Cathode (2)

Note that the cathode material of constructed is selected to accomplish the desired electrochemical change for CO2 capture (OH— generation), and/or CO2 reduction to a carbonaceous compound or compounds, and/or reduction of one or more other carbonaceous organic spent fuel cell exhaust constituents. Also note that the fuel cell exhaust may and most likely will still contain unreacted fuel values as complete consumption of fuel may be inefficient for power generation.

### Step 3. Transport of Mn+ Ions to the Catholyte

H+ions (photocatalyst)→H+(Anolyte) (3)

H+(Anolyte)+MxCO3(Anolyte)→Mn+(Anolyte)+HCO3−(Anolyte) (4)

Mn+(Anolyte)→Optional PEM→Mn+(Catholyte) (5)

### Step 4. Generation of Hydroxide Ions at the Cathode

H2O+e−+Mn+(Catholyte)=M(OH)n+½H2 (6)

Step 5. CO2 Capture from fuel cell Exhaust or Breathing Air

CO2(g)+M(OH)n→MxCO3 (7)

Where Mn+ is a metal cation, normally an alkali or alkaline earth metal ion, alone or as a blend of such cations. Mn+ can be Li+, Na+, K+, Rb+, C+, Be2+, Mg2+, Ca2+, Sr2+, Zn2+, Fe2+, a rare earth (M3+), and the like. M species that are most preferred are those that form very soluble solutions with carbonate and/or bicarbonate ion. Where the carbonate salt is water soluble, then it is preferred that the CO2 capture be from the gas phase by a solid sorbent. (Reaction 8).

CO2(g)+M(OH)n(solid)→MxCO3(solid) (8)

The solid then is reacted with anolyte containing photo-generated H+ ions in the anolyte, after the removal of the oxygen contained therein, to reform the water-soluble bicarbonate solution (Reaction 9).

xH+(Anolyte)+MxCO3(solid)→M(HCO3)x(solution) (9)

The next step is to reform the Anolyte and release pure (but moist) CO2 by contacting the bicarbonate solution with more oxygen-free Anolyte in a second reaction (Reaction 10).

M(HCO3)x(solution)+xH+(oxygen-free Anolyte)→Mn++xH2O+xCO2(gas) (10)

Where it is most preferred that the CO2 be contained during Reaction 10 such that it is chemically pressurized.

All of the above reactions are fast and high yielding, essentially 100%, and react very fast, normally less than one second.

### EXAMPLE 3

### Carbonate-Based Means to Use PDEC to Regenerate Spent FC Fuel to Accomplish FCFR

In this example, the PDEC substrate is used to accomplish the water conversion to oxygen, hydrogen ions and electrons, which in part drive carbonation chemical changes to capture CO₂ from spent fuel cell fuel, reformer off gas, exhaled breathing air, and the like. Upon capture, the CO₂ can be reduced to carbonaceous food and/or fuel, for example fuel cell fuel, or regenerated as CO₂ gas, preferably under pressure. Such pressurized CO₂ is useful for release as a waste to the local environment, even at conditions where significant back pressures exist from ambient carbon dioxide, and is present for example on Mars or in green houses. Another benefit is that it enables the use of lithium hydroxide or lithium hydroxide to remove CO2 from breathing and fuel cell or reformer off gases. The following description describes this preferred aspect of the invention.

The materials to prepare the device used for the carbonate-based fuel cell fuel regeneration to bring about charge separation via photoactivation are the same or similar to those used to apply PDEC in other forms to first form active oxygen within a metal oxide film, preferably a film or slurry particle of titania, or other photocatalyst, alone or doped with certain metal ion sensitizers, carbon, graphite, and/or organic or organometallic dyes to enhance photolysis yield and to enable use of broad wavelength ranges of the electromagnetic spectrum. In film form, the photocatalyst is in intimate contact with a transparent metallic or semiconductor element, preferably a film or a screen, where illumination is to be throughout catalyst film. For slurried photocatalyst and where the illumination is to be of the slurry and a electrical conducting layer is not desired, the slurry can be clear, translucent or opaque and/or poorly transmitting since the slurry particles, gel or packed bed photocatalyst is selected to be photochemically efficient for producing the desired charge separation over at least a portion of the spectrum of the light used to accomplish the illumination. The electrolyte can be any salt solution, including dilute (1-1000 mM) to concentrated (1-50 wt % or ionic liquids) metal salts, blends of salts and/or pH buffers, stabilizers, solubility enhancers, emulsifiers, combinations of these materials, and the like. Preferably these materials are selected such that the resultant electrolyte only strongly absorb light in a manner to produce the desired charge separation (excitons) and the desired products (active oxygen, oxygen, and, in the case of slurries, chemically reduced products), and little else, and are not themselves significantly photo-degraded in a manner causing them to become ineffective in their role in the electrolyte.

For photocatalyst catalyst construction, films or slurries are useful. These slurries can be suspensions of particulates and can be colloids, microcolloids, or combinations of these. Slurries of titania, tungsten oxide, zinc oxide, or whole venous blood, and the like are acceptable materials. Opaque electrolytes, slurries and colloids are useful to practice the invention provided the photocatalyst is not illuminated through the electrolyte and is instead illuminated through the supporting conductor-photocatalyst film. An example of the latter case is where the conductor film is deposited upon a glass, quartz, or clear and colorless plastic material, so that the light can enter the photocatalyst via the this clear substrate.

The particularly useful carbonate-based mode of operation of the invention is described as follows.

This example illustrates how CO₂ is collected from FC exhaust gases and/or from accumulations in confined breathing atmospheres and processed back into fuel or food, or discharged as desired, while producing O2 gas from the moisture present in such fluids, liquid or gas, using the following series of steps.

Step 1. Photolysis to produce oxygen, hydrogen ions and electrical current (available electrons) in a first PDEC anode compartment.

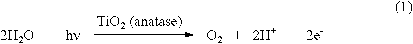

The oxygen is sent to storage for eventual re-use for breathing or fuel combustion.

Step 2. Transport of Electrons to Cathode (electrical current)

2e⁻→Electrical Conductor/semi-conductor Film→Cathode (2)

### Step 3. Alkaline Scrubber Solution Prepared at the Catholyte

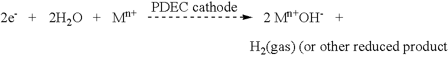

The cathode material of construction is selected to accomplish the desired electrochemical change for CO₂ capture (preferably OH⁻ generation), and/or, most preferably, CO₂ chemical reduction to a carbonaceous compound or compounds, and/or reduction of one or more other carbonaceous organic or inorganic spent fuel cell fuel (exhaust) constituents, preferably in high yield and especially with none or minimum formation of byproducts. Also note that the fuel cell exhaust, especially if the fuel cell is liquid based, may be expected to contain unreacted fuel values since complete consumption of fuel may be inefficient for power generation for some fuel cells, especially those using liquid electrolytes.

Step 3. Transport of M⁺ⁿ Ions into the Catholyte

H⁺ions (photocatalyst)→H⁺(Anolyte) (3)

xH⁺(Anolyte)+MₓCO₃(Anolyte)→Mⁿ⁺(Anolyte)+HCO₃⁻(Anolyte) (4)

Mⁿ⁺(Anolyte)→PEM (Optional)→Mⁿ⁺(Catholyte) (5)

### Step 4. Generation of Hydroxide Ions at the Cathode

H₂O+e⁻+1/nMⁿ⁺(Catholyte)=1/n M(OH)ₙ+½H₂ (6)

Step 5. CO2 Capture From Fuel Cell Exhaust or from Breathing Air

CO₂(g)+xM(OH)ₙ→MₓCO₃+H₂O (7)

Where a portion of the product can include the corresponding metal ion bicarbonate. This carbon dioxide capture is accomplished using a gas-liquid contractor device, either designed as liquid sorbent/gas scrubbing, solid sorbent/gas, or other the like, including a contractor specifically designed for minimum gravity if used in low or zero-G use when the application of the invention is used in such environments.

Step 6. Prevention of CO₂ Gas Evolution or Acidification of the Cathodic PDEC Compartment by Consumption of H⁺ ions Produced at the Anode

xH⁺(Anolyte)+MₓCO₃(Anolyte)→Mⁿ⁺(Anolyte)+HCO₃⁻(Anolyte) (4)

Control of carbon dioxide gas evolution in the anolyte compartment is necessary so that product oxygen gas is not significantly contaminated with carbon dioxide gas. Hence, for Reaction 4, an excess of MₓCO₃ is provided and the pH is maintained above about 8, and preferably above about 9.

### Step 7. Fuel Cell Fuel Regeneration at the Cathode

Where Mⁿ⁺ is a metal cation, normally an alkali or alkaline earth metal ion, alone or as a blend of such cations. Mⁿ⁺ can be Li⁺, Na⁺, K⁺, Rb⁺, C⁺, Be²⁺, Mg²⁺, Ca²⁺, Sr²⁺, Zn²⁺, Fe²⁺, a rare earth (M³⁺), and the like. M species that are most preferred are those that form very soluble solutions with carbonate and/or bicarbonate ion. Where the carbonate salt is water soluble, then it is preferred that the carbon dioxide capture be from the gas phase by a solid sorbent. (Reaction 8).

CO₂(g)+M(OH)ₙ(solid)→MₓCO₃(solid) (8)

The solid then is reacted with anolyte containing photo-generated H⁺ ions in the anolyte, after the removal of the oxygen contained therein, using a gas-liquid separation device to reform the water soluble bicarbonate solution (Reaction 9).

xH⁺(Anolyte)+MₓCO₃(solid)→M(HCO₃)ₓ(solution) (9)

The next step is to reform the Anolyte and release pure (but moist) carbon dioxide by contacting the bicarbonate solution with more oxygen-free Anolyte in a second PDEC anolyte reaction using the first compartment and not making oxygen, or preferably using a different PDEC anodic cell compartment (Reaction 10).

M(HCO₃)ₓ(solution)+xH⁺(O₂-free Anolyte)→Mⁿ⁺+xH₂O+xCO₂(gas) (10)

Where it is most preferred that the carbon dioxide is contained during Reaction 10 such that it is chemically pressurized.

All of the above reactions are fast and high yielding, essentially 100%, and react very fast, normally less than one second.

In summary, the use of a PDEC powered cell with carbonate electrolyte enables the removal of carbon dioxide from exhausted or spent breathing air and/or from fuel cells. The nonvolatile nature of carbonate/bicarbonate solution is used to separate the absorbed carbon dioxide, as carbonate/bicarbonate ion form, from oxygen gas while absorbing the hydrogen ions produced by the PDEC photocatalyst. The caustic or alkalinity for the absorption of the carbon dioxide gas is produced at the PDEC cathode in the usual manner while the fuel or carbon(IV), originally from the carbon dioxide is chemically reduced to useful compounds at the cathode, more preferably to fuels and/or to foods, or other materials. Alternatively, the carbon dioxide can be released in concentrated form, preferentially pressurized form, by passing the carbonate/bicarbonate electrolyte through another, or the same in series, anolyte compartment. Solid sorbent materials can also be fabricated from the caustic materials produced to use to prepare canisters of carbon dioxide sorbent material to use, for example, to maintain low carbon dioxide levels in breathing air or in rebreather devices.

| | | Compound | |
|---|---|---|---|
| | | after 2e- | |
| | | Reduction | Compound |
| | | (except | after |
| | | where | Reduction |
| | Structure | noted) | w/CO2 |
| Sorbic Acid | 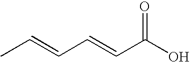 | 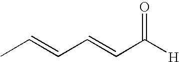 | 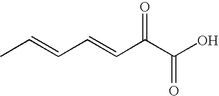 |
| Vitamin E(Tocopherol) | 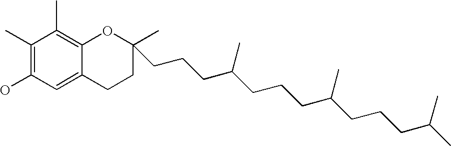 | 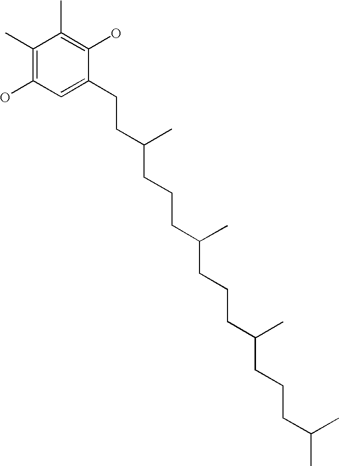 | 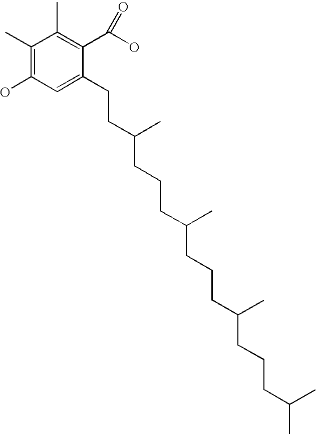 |
| Mannose | 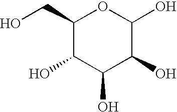 | 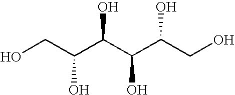 | 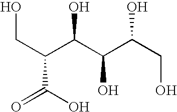 |
| Fructose | 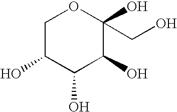 | 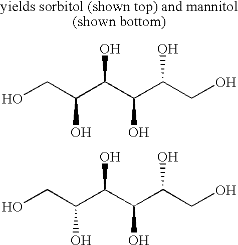 | 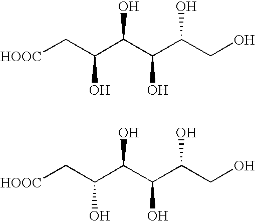 |
| Carbonic Acid | 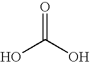 | 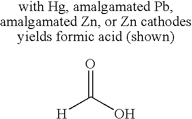 | 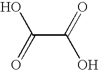 |
| Lactic Acid | 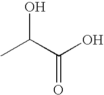 | 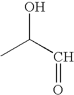 | 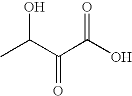 |
| Levulinic Acid | 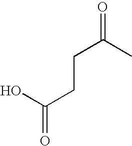 | | |
| Aliphatic Aldehydes (ex:Formaldehyde)(Acetaldehyde andIsobutyraldehyde also work) | 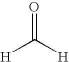 | in basic medium yields respectiveAlcohol (shown); in acidic tendency toyield Hydrocarbon (same forAcetaldehyde as well as possible 2,3-butanediol with high overpotentialcathode (ex: Hg) and acidic medium;Isobutyraldehyde yields isobutane,isobutene, and isobutyl alcohol basedon cathode and temperature)CH₃OH | 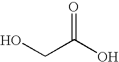 |
| Glucose | 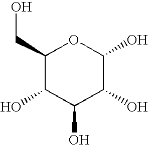 | 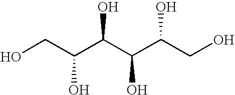 | |
| Vanillin | 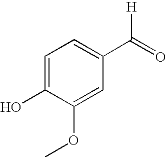 | yields hydrovanilloin | |
| Oxalic Acid | 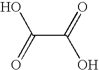 | 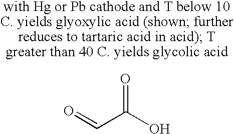 | 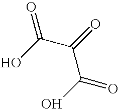 |
| Naphathalene | 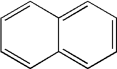 | 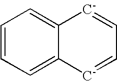 | 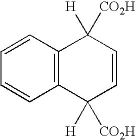 |
| Diphenylacetylene | 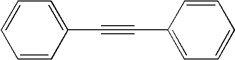 | 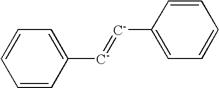 | 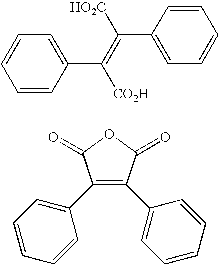 |
| Phthalimides (ex:Phthalimide)(Hydroxyphthal-imide and Nmethylphthalimide alsowork) | 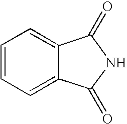 | 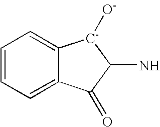 | 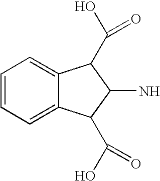 |
| Azoxybenzenes (ex:Azoxybenzene) | 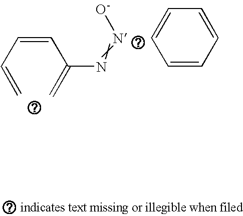 | 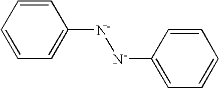 | 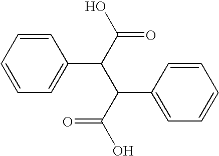 |
| m-Nitrophenol (o- and p-also work) | 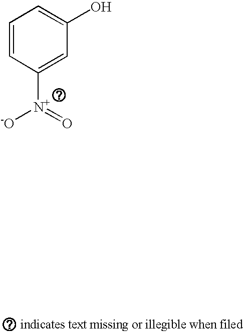 | 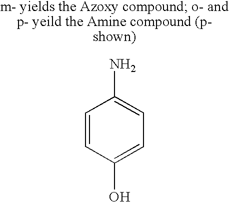 | 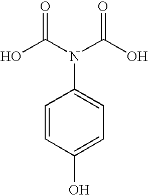 |
| 2,6-Dinitrotoluene | 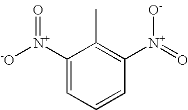 | 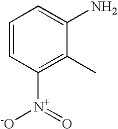 | 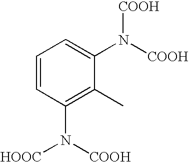 |
| Chloropicrin | 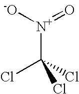 | 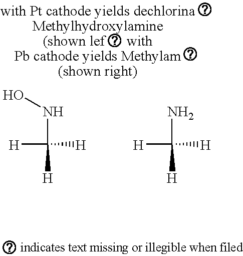 | 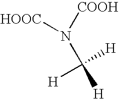 |
| Nitramines (ex: Nitramine) | 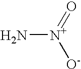 | 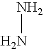 | 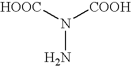 |
| m-Nitrobenzaldehyde | 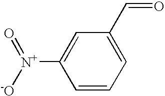 | 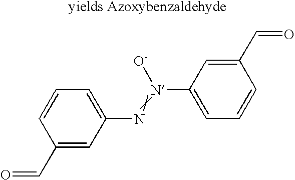 | |
| Aliphatic Ketones (ex:Acetone) (Methyl EthylKetone also works) | 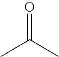 | with Pb cathode yields both the pinacoland isopropyl alcohol; with Hg cathodeyields isopropyl alcohol and propane; atPb w/o air yields Pb(C3H7)2 andPb(C3H7)4 (for Methyl Ethyl Ketonewith Pb cathode yields secondary butylalcohol and/or methyl ethyl pinacol) | |
| Cuminaldehyde | 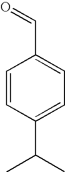 | yields hydro- and isohydrocuminoin | |
| Salicylaldehyde | 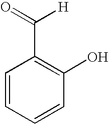 | yields hydrosalicyloin | |
| p-Acetamido-benzaldehyde | 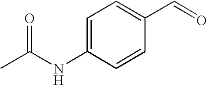 | with Hg cathode yields 4,4′-bis-p-acetamidohydrobenzoin | |
| Furfural | 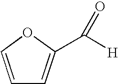 | with Pb cathode yields a mixture ofhydrofuroin and isohydrofuroin | |
| p-Aminoaceto-phenone | 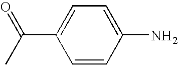 | 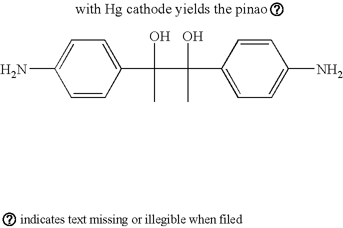 | |
| p-Hydroxyaceto-phenone | 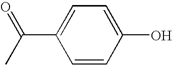 | 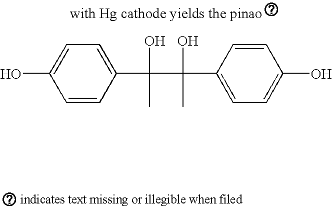 | |
| p-Dimethylamino-acetophenone (p-Carboxyaceto-phenonealso works) | 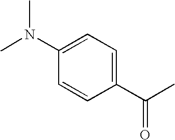 | 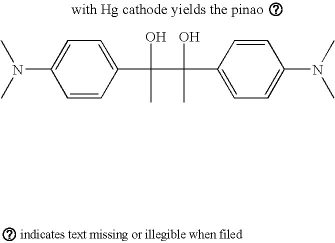 | |
| Phenylacetic Acid | 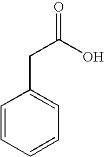 | 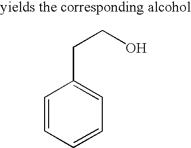 | |
| m-Nitrobenzoic Acid (o-also works) | 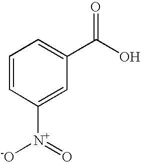 | 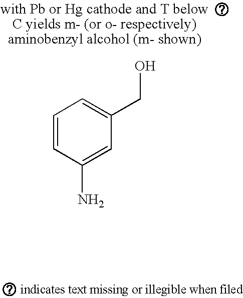 | |
| 3-Hydroxybenzoic Acid | 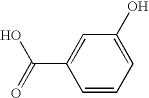 | 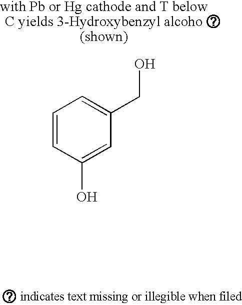 | |
| 2-Carboxybenzaldehyde | 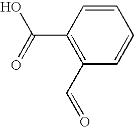 | 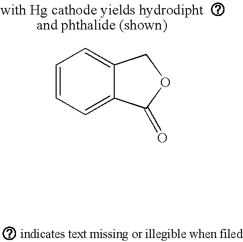 | |
| Acetoacetic Acid(Butylacetoacetic Acid andIsobutylacetoacetic Esteralso work) | 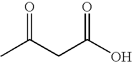 | 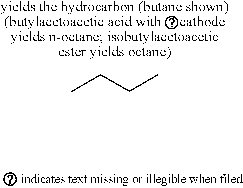 | |
| N-Methyl-alpha-phenylacetamide (N,N-dimethyl-alpha-phenylacetamide alsoworks) (N-Methyl-2-phenylacetamide shown) | 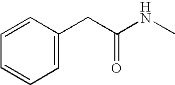 | 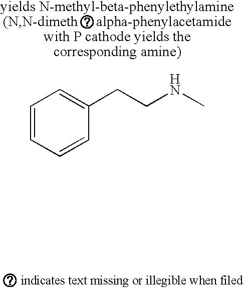 | |
| Cyclic imides (ex:Succinimide) (N-methyl-, N-ethyl-, N-isopropyl-, and N-phenyl also work) | 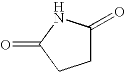 | 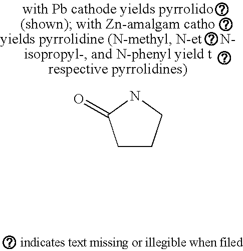 | |
| Xanthine (Theophyllin alsoworks) | 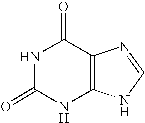 | 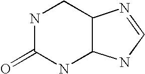 | |
| Aromatic Acids (ex:Pentafluorobenzoic Acid)(3,5-Dibromo-2-Hydroxybenzoic Acid (I)and 5-Chloro2-Hydroxybenzoic Acid (II)also work) | 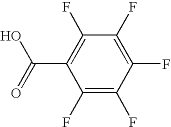 | | |
| alpha-,beta-Unsaturatedand Aromatic Esters (ex:Methyl Benzoate) (Ethyl-and Isopropyl- also work) | 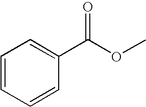 | 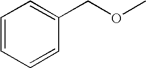 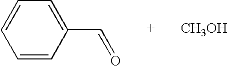 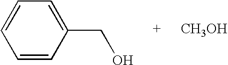 | |
| Aromatic Carboxylic Acids(ex: Benzoic Acid) | 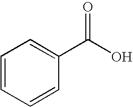 | 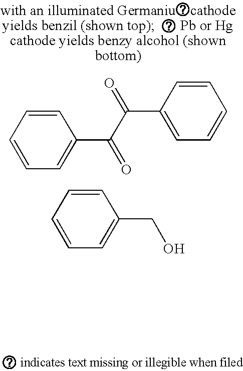 | |
| Phenyl Benzoate (Benzyl-,ethyl o-chloro-, and m-bromobenzoate also work) | 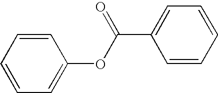 | yields the respective ethers | |
| Monoethyl Phthalate(Diethyl also works) | 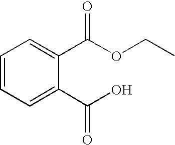 | 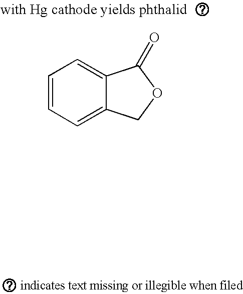 | |
| Benzamides (ex:Benzamide) (N-substitutedalso work) | 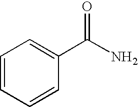 | 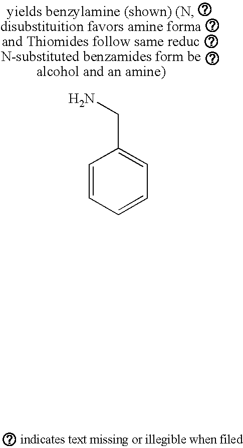 | |
| Nitriles of the TypeXC6H4CN or XC5H3N withX = H, p-COOH, p-SO2NH2, or m-SO2NH2(ex: 2-Cyanopyridine) (4-also works) | 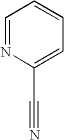 | 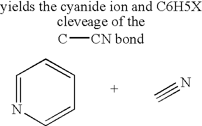 | |
| Phthalonitrile | 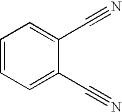 | 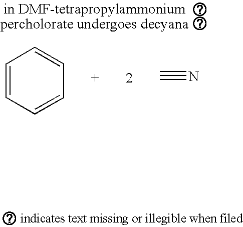 | |
| Benzaldehyde | 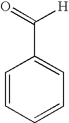 | 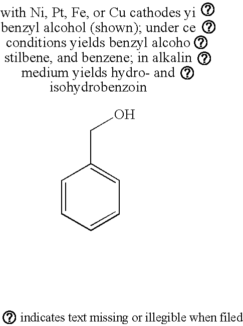 | |
| Mannich Bases (ex: p-Acetamido-omega-dimethylamino-propiophenone) | 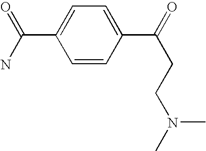 | 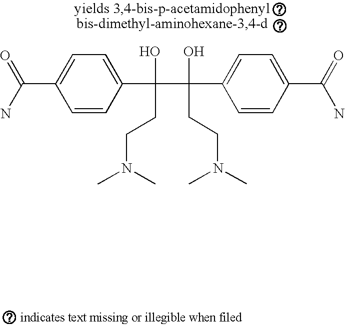 | |
| bi- or tri-Cyclic alpha-Aminoketones (ex: 7-keto-1-azabicyclo 6.4.0 dodecane) | 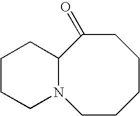 | 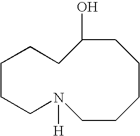 | |
| 1-Ethyl-4-Carboxypyridinium [ion] | 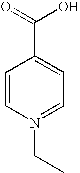 | 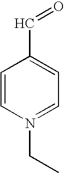 | |
| N-Phenyl-4-Pyridinecarbox-amide | 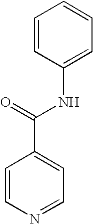 | 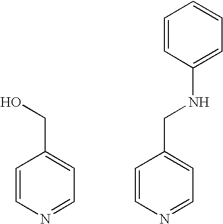 | |
| Acetylene | 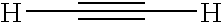 | 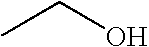 | |
| Imino Ether Hydrochlorides | | with Pb cathodes yields amines | |
| Ethyl Esters of Fumaric,Tartaric, and Succinic Acids(Ethyl Succinate shown) | 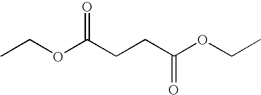 | | |
| Pyridine-2-Carboxylic Acid(Pyridine 4-, Imidazole-2-,and Thiazole-2-CarboxylicAcid also work) | 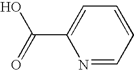 | 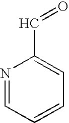 | |
| Methyl 2-Napthoate (Methyl1-naphthoate also works) | 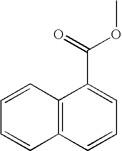 | 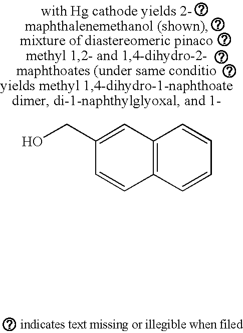 | |
| Lactones (ex: D-Ribone-gamma-Lactone) | 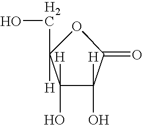 | 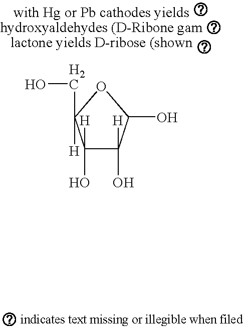 | |
| Thioesters (containing—C(O)SR, —C(S)OR, and —C(S)SR functions) | 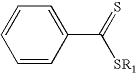 | 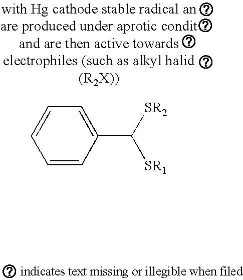 | |
| Pyridine-4-Thiocarboxamide | 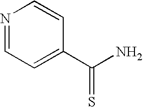 | 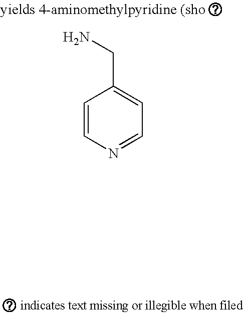 | |
| Acyl Hydrazides (ex: 4-Pyridinecarboxylic AcidHydrazide) | 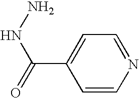 | 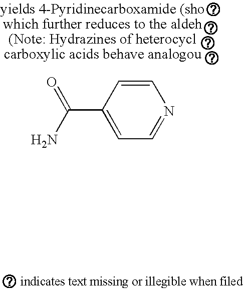 | |
| alpha, beta-Unsaturated | | under non-acidic conditions undergo | |
| Nitriles | | hydrodimerization | |
| Nitrobenzene (with ortho-N(CH3)2, o-COCH3, o-OCH3, and o-CH3 alsowork) | 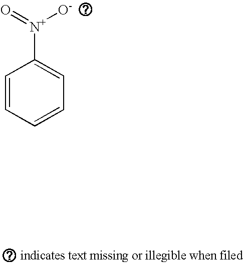 | 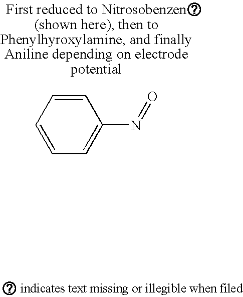 | |
| Azobenzenes (ex:Azobenzene) | 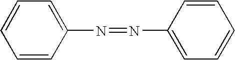 | 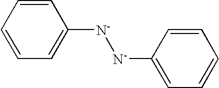 | |
| m-Nitroaniline (o- and p-also work) | 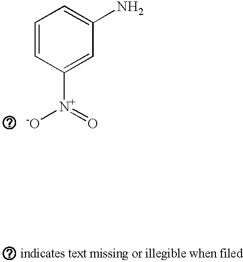 | 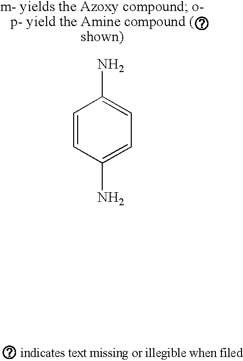 | |
| Nitromethane (Nitroethaneand Nitropropane alsowork) | 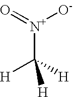 | 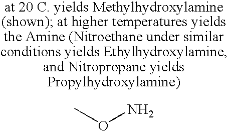 | |
| Nitrosamines (ex:Nitrosamine) | 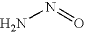 | 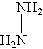 | 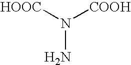 |
| Benzalanilines (ex:Benzalaniline) | 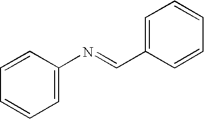 | 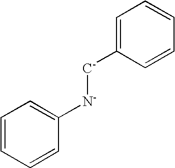 | |
| Glyoxylic Acid | 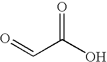 | 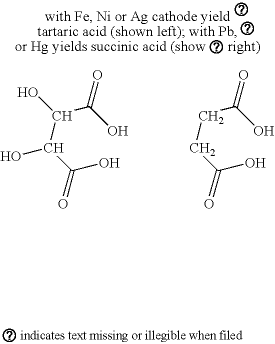 | |
| Cycloparaffin ketones/Aromatic Aldehydes (ex:Cyclopentanone) | 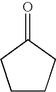 | 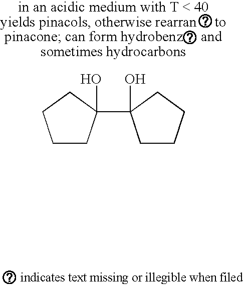 | |
| p-Dimethylaminobenzaldehyde | 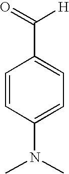 | 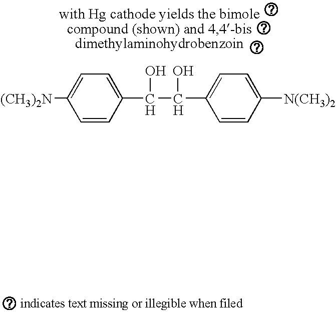 | |
| p-Hydroxybenz-aldehyde | 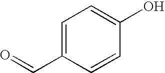 | 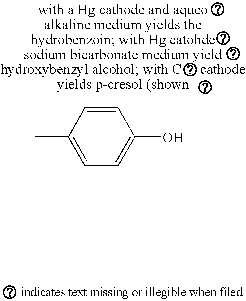 | |
| Aromatic Ketones (ex:Benzophenone | 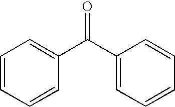 | with high overpotential cathode andaqueous acidic medium yieldsbenzpinacone; with high or low (Fe, Ni,Cu) overpotential electrode in acetic-sulphuric medium yields the pinacone | |
| p-Aminopropio-phenone | 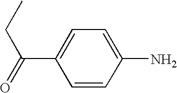 | 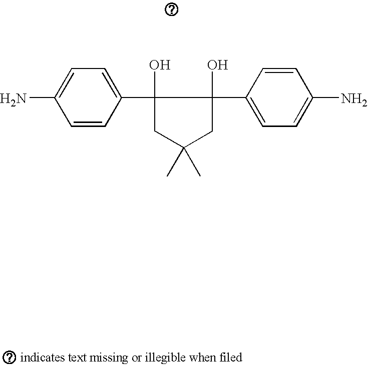 | |
| beta-Acetyl Pyridine | 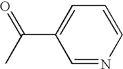 | 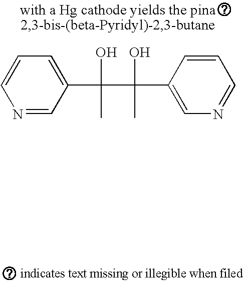 | |
| Formic Acid | 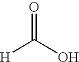 | with Pb electrode yields formaldehydeat low current density or methanol athigh current density | |
| m-Chlorobenzoic Acid (o-and p- also work) | 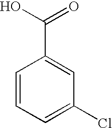 | 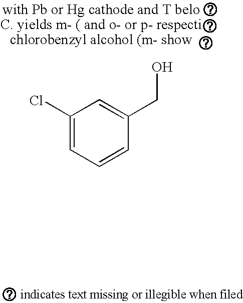 | |
| m-Bromobenzoic Acid | 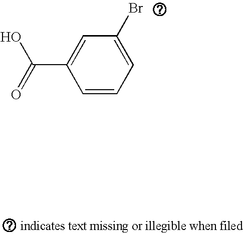 | 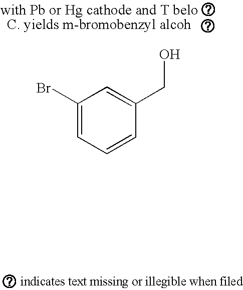 | |
| Salicylic Acid | 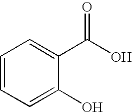 | 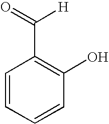 | |
| Aromatic Dicarboxylic Acids(ex Phthalic Acid)(Isophthalic Acid alsoworks) | 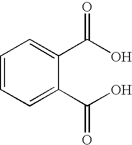 | 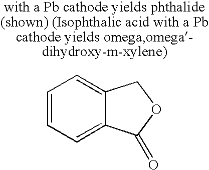 | |
| alpha-Phenyl-acetamide | 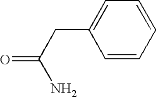 | 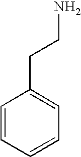 | |
| Diketopiperazines (ex:Diketopiperazine) | 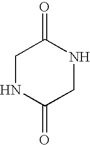 | 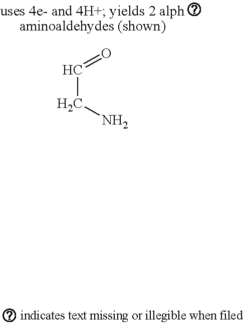 | |
| Barbituric Acid (5,5-diethylbarbituric acid alsoworks) | 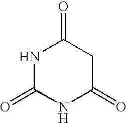 | 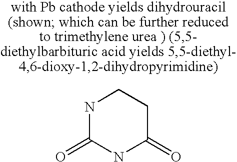 | |
| Phenylacetic Acid | 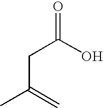 | 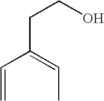 | |
| Dimethyl Terephthalate | | undergoes same 3 reductions as | |
| | | methyl benzoate | |
| Phthalic Anhydride | 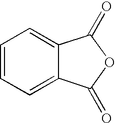 | yields phthalide (shown) (Note:possible monoethyl phthalate assubstrate) | |
| Diethyl Terephthalate | | yields the aldehyde ester under CPE | |
| (Diethyl Furan- and | | conditions | |
| Thiophene-2,5- | | | |
| Dicarboxylate also work) | | | |
| Dimethyl Adipate | | yields n-hexane (shown) | |
| N,N-Dimethylbenz-amide | | | |
| (N-Alkylphthalimides and | | | |
| Oxamides also work) | | | |
| Substituted Phthalamides | | yields O-acetyl-2- | |
| (ex: N-Phenylphthalimide) | | hydroxymethylbenzanilide | |
| Benzonitrile | | in DMF-tetrapropylammonium | |
| | | perchlorate yields solutions of relatively | |
| | | stable anion radicals | |
| 1,5-Dinitro-naphthalene | | with Pb cathode yields 1,5-naphthalene | |
| | | diamine | |
| Amino Ketones (ex: p-Aminopropio-phenone) | 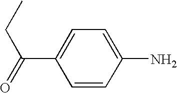 | 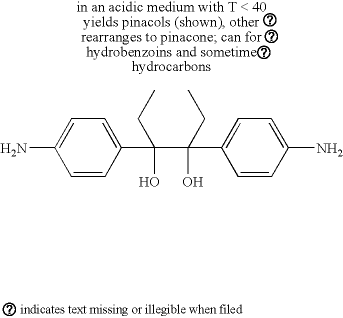 | |
| alpha-Aminoketones (ex: 1-Methyl-2-Ethyl-3-Piperidone) | 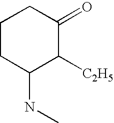 | 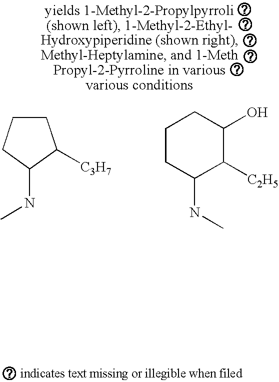 | |
| Morpholinone Series(~cyclic amides) | 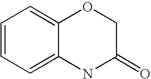 | 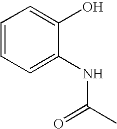 | |
| Ethyl 2-Thiazolecarb-oxylate | 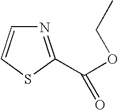 | 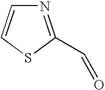 | |
| Imidic Esters (ex: EthylAcetimidate) | 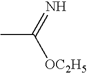 | CH₃CH₂NH ₂ + C₂H₅OH | |
| Stilbene | 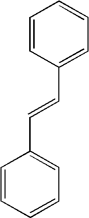 | 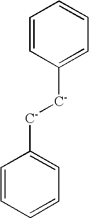 | 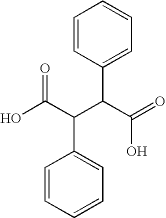 |
| p-Carboxyaceto-phenone | 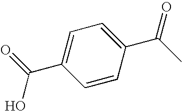 | 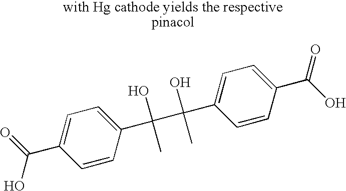 | |
| Esters of Oxalic, Malonic,Acetoacetic, Oxalacetic,Benzoic, Halobenzoic, andPhthalic Acids (ex: DimethylMalonate) | 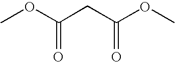 | | |
| Diethyl Oxalate | 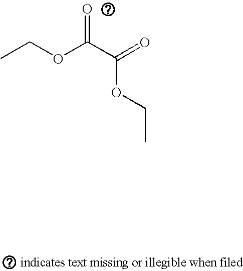 | with a Hg cathode yields the ethylhemiacetal of ethyl glyoxylate | |
| 2-Alkyl substitutedAcetoacetic Esters andbeta-Diketones (Ethyl 2-Butylacetoacetate) | 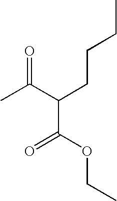 | 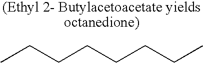 | |
| Thiol Esters of AromaticAcids (ex: S-Benzoyl-L-cysteine) | 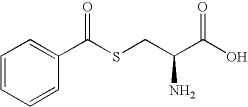 | 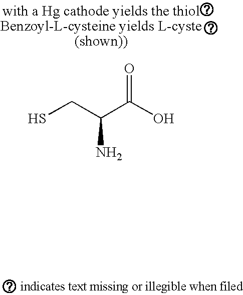 | |
| Carboxamides ofHeterocyclic Systems (ex:Pyridine-4-Carboxyamide) | 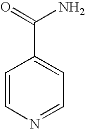 | 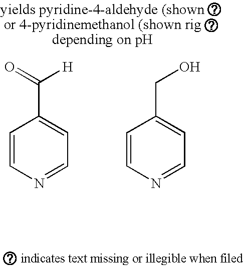 | |
| N,N-Dimethyl and N,N- | | with a Pb cathode yields the | |
| Diphenyl-substituted | | corresponding aminomethyl | |
| Aliphatic Amides | | compounds | |
| Ethyl Ester of AcetoaceticAcid | 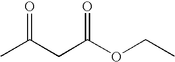 | 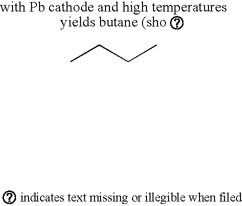 | |
| Anisaldehyde (ex: p-Anisaldehyde) | 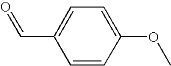 | yields hydro- and isohydroanisoin | |
| Aliphatic Nitrites (ex:Heptanecarbo-nitrile)(Cycloheptane-carbonitrilealso works) | 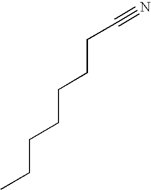 | yields cleveage of the C—CN bonds | |
| Aromatic Nitriles (ex p-RCOC6H4CN with R = H(top) or CH3(bottom)) | 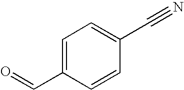 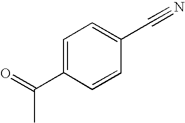 | yields the corresponding benzylamine | |

While the forms of the invention herein disclosed constitute presently preferred embodiments, many others are possible. It is not intended herein to mention all of the possible equivalent forms or ramifications of the invention. It is to be understood that the terms used herein are merely descriptive, rather than limiting, and that various changes may be made without departing from the spirit of the scope of the invention.

We claim:

1. A method for providing a human habitation in an enclosed space comprising:
A. providing an enclosed space for human habitation;
B. photolytically converting CO2 and/or H2O, wherein the CO2 and/or H2O are optionally at least partially generated within the enclosed space, to a product comprising one or more of a chemical, fuel, food, oxidant, and/or one or more intermediates for the same and providing at least a portion to the enclosed space;
C. producing energy, from one or more of the products of step B; and
D. recycling the spent reactants from energy production and/or from respiration to step B.

2. The method according to claim 1, wherein the CO2 and/or H2O of step B are at least partially from one or more of the following: respiration of an inhabitant, fuel cell exhaust, and reformer off gas.

3. The method according to claim 1, wherein the product of step B comprises one or more of the following: oxygenated hydrocarbon, hydrocarbon, carbohydrate, oligomer, polymer, hydrogen, oxygen, carbon, paraformaldehyde, and a chemical intermediate.

4. The method according to claim 3, wherein the hydrocarbon is ethylene and/or methane.

5. The method according to claim 3, wherein the carbohydrate is a formaldehyde, a trioxane, or sugar.

6. The method according to claim 1, wherein C5 sugars are provided in step B for conversion with CO2 to C6 sugars.

7. The method according to claim 1, wherein the enclosed space is a spacesuit, a space station, a lunar building or colony, a Mars building or colony, a space ship, a lunar or planetary land rover, or a terrestrial survival unit.

8. The method according to claim 1, wherein the gas pressure within the enclosed space is maintained below one earth atmosphere.

9. The method according to claim 8, wherein the gas pressure within the enclosed space is maintained between about 0.4 to about 0.8 of one earth atmosphere.

10. The method according to claim 1, wherein two or more enclosed spaces are provided in step A.

10. The method according to claim 1, wherein at least a portion of the product is a rocket fuel.

11. A method for providing energy and reactants to an enclosed space comprising:
A. providing an enclosed space;
B. photolytically converting CO2 and/or H2O, wherein the CO2 and/or H2O are optionally at least partially generated within the enclosed space, to a product comprising one or more of a chemical, fuel, food, oxidant, and/or one or more intermediates for the same and providing at least a portion to the enclosed space;
C. producing energy, from one or more of the products of step B; and
D. recycling the spent reactants from energy production to step B.

12. A method for providing a power source and maintaining a human breathing atmosphere in an enclosed space comprising:
A. providing an enclosed space for human habitation;
B. photolytically providing an oxidant, electrons/electrical current, and hydrogen ions,
C. Using these electrons and hydrogen ions for converting CO2, chemically oxidized organic or inorganic compounds, and/or H2O, wherein the CO2, chemically oxidized organic and/or inorganic compounds, and/or H2O are optionally at least partially generated within the enclosed space, to a product comprising one or more of a chemical, fuel, food, oxidant, chemically reduced organic or inorganic compound(s), and/or one or more intermediates for the same;
D. producing energy, from one or more of the products of steps B and/or C; and
E. recycling the exhaust materials from energy production and/or from human respiration to step B.

13. The method according to claim 12, wherein the CO2, oxidized organic or inorganic compound(s), and/or H2O of step C are at least partially from one or more of the following: respiration air of one or more inhabitants, fuel cell exhaust, and/or reformer off gas.

14. The method according to claim 12, wherein the product of step C comprises one or more of the following: oxygenated hydrocarbon, hydrocarbon, carbohydrate, oligomer, polymer, hydrogen, oxygen, carbon monoxide, carbon, paraformaldehyde, trioxane, reduced inorganic compound, hydroquinone, and a sulfoxide,

15. The method according to claim 12, wherein the product of step C comprises one or more of the following: a chemical intermediate, an electrochemically active organic compound, and mixtures thereof.

16. The method according to claim 14, wherein the hydrocarbon is ethylene, ethane, propane, propylene, isobutane, isobutane, butane, butylene, methane, Fisher Tropsch products, and/or mixtures of these materials.

17. The method according to claim 14, wherein the carbohydrate is a formaldehyde, paraformaldehyde, a trioxane, or a sugar, or any combination of these materials as well as isomers, C-5 sugars, C-6 sugars, glucosides, and the like.

18. The method according to claim 14, wherein the reduced inorganic compound is one or more of water,
N2,
Fe(II), Pb(II), Mn(II), V(III), Ce(III), Cr(III), TI(I), Hg(I)22+, Cu(I), V(IV)O2+ ion, V(V)O2+ ion, and/or other metal ions, including oxo-containing ions, alone, aquated, chelated, or complexed,
sulfate, sulfite, thiosulfate, dithionite, sulfide, ions, and/or other reduced form of sulfur or S-containing peroxides
borate ion, boron hydrides, cyanoborohydrides, and/or other reduced form of boron or B-containing peroxides
silver, nickel, copper, gold, iron, cadmium, lead, zinc, manganese, or other metal or metal mixture,
ammonia, ammonium ion, hydrogen cyanide, hydroxylamine,
hydrogen peroxide or a metal peroxide,
bromate ion,
MnO2, ZnO, InSnO (ITO), As2O3, manganate, FeO, PbO, SnO, and other redox active solid metal and metalloid oxides
hypochlorite, iodate ion, I2, hydrazine, chloride ion, bromide ion, iodide ion, chlorous add, clorate ion,
N2O, N2O4, H2N2O2, nitrous add, NO,
elemental sulfur (S, S8), elemental phosphorus (P, P4), hypophosphite ion, phosphonate ion, phosphine (PH3) and phosphine derivatives, ferrocyanide,
and the like, and mixtures of these materials.

19. The materials of claim 18, alone, as liquids, as solids, immobilized in membranes or gels, or present as aqueous solutions, in polar solvents, molten salts, or in combination of such solvents, and/or including inert salts and at any pH between −2 and +16.

20. The method according to claim 12, wherein C5 sugars are provided in step C for conversion with CO2 into C6 sugars.

21. The method according to claim 12, wherein the enclosed space is a spacesuit, a space station, a lunar building or living module, or enclosed colony, a mars building or living module, or enclosed colony, a near earth or interplanetary space ship, a lunar, mars, or planetary land rover, an underwater, under sea, unit, a underwater rescue unit, or a terrestrial survival unit.

22. The method according to claim 12, wherein the gas pressure within the enclosed space is maintained below one earth atmosphere.

23. The method according to claim 20, wherein the gas pressure within the enclosed space is maintained between about 0.4 to about 0.8 of one earth atmosphere.

24. The method of claim 12, wherein the power supply is about 5 kilowatts or less.

25. The method according to claim 14, wherein the oxidized inorganic compound is one or more of
Hydrogen peroxide,
Fe(II, III,VI), Pb(IV), Mn(III,IV,V,VI), V(IV, V), Ce(IV), Cr(VI), Ti(III), Hg(II), Cu(I,II), Ag(I,II), Ni(II, III, IV), Au(I, III), Cd(II), Zn(II), V(IV)O2+ ion, V(V)O2+ ion, and/or other metal ions, including oxo-containing ions, halide complexes, pseudo halide complexes, hydroxide complexes, alone, aquated, chelated, or complexed with ligands,
persulfate ion, and/or other oxidized forms of sulfur or S-containing peroxides perborate ion, and/or other oxidized forms of boron or B-containing peroxides hydroxylamine, nitrite ion, nitrate ion, cyanogen, H2N2O2, N2O4, nitrous acid, nitric acid,
hydrogen peroxide or a metal peroxide such as barium peroxide, MnO2, ZnO, InSnO (ITO), As2O5, permanganate (MnO4-), Fe3O4, KOH/K2FeO4 blends, LiOH/Li2FeO4 blends, other blends of ferrate(VI) involving alkali and/or alkaline earth ions, PbO2, SnO2, and other redox active solid metal and metalloid oxides
bromate ion, hypochlorite, periodate ion, I2, Br2, chlorous acid, clorate ion, phosphonate ion
N2O, N2O4, H2N2O2, nitrous acid, NO,
Ferricyanide ions,
and the like, and mixtures of these materials with any metal ion or hydrogen ion or oxide/hydroxide ion required for an over all neutrally charged material.

26. An apparatus for fuel regeneration and oxygen production comprising:
A. a PDEC cell comprising a photo anode that absorbs light and carries out oxidation; and a cathode, optionally separated by a separator or membrane to form an anode and cathode compartment; and
b. a fuel cell having its exhaust connected to the PDEC cell, wherein the exhaust water flows to the anode side and oxidized or spent fuel flows to the cathode side of the apparatus.

27. An apparatus for fuel regeneration comprising:
A. a PDEC cell having an inlet and an outlet and a photoanode and a cathode, optionally separated by a separator or membrane to form an anode and a cathode compartment; wherein the cathode is permeable to gas; and
B. a fuel cell connected to the PDEC cell, wherein spent fuel is sent to the PDEC cell for regeneration.

28. The apparatus of claim 65, wherein a gas separator for oxidized fuel is between the exhaust of the fuel cell and the PDEC cell wherein a basic material is contacted with gaseous spent fuel.

29. An apparatus for regenerating spent fuel using photolytic energy comprising:
A. a PDEC cell having walls transparent to light and having an inlet and an outlet, and a filter in the inlet and outlet, forming a chamber; and
B. a photocatalyst slurry within a chamber.

30. The apparatus according to claim 70, comprising:
C. a fuel cell, optionally having a gas fuel exhaust separator between the PDEC cell and a fuel cell, and wherein the outlet of the fuel cell is connected to the inlet of the PDEC cell.

31. All novel apparatus, methods, and uses disclosed herein.
